(19) United States
(12) Patent Application Publication
(10) Pub. No.: US 2020/0008247 A1
(43) Pub. Date: Jan. 2, 2020

(54) NR (NEW RADIO) PRACH (PHYSICAL RANDOM ACCESS CHANNEL) CONFIGURATION AND MULTI-BEAM OPERATION

(71) Applicant: Intel IP Corporation, Santa Clara, CA (US)

(72) Inventors: Yongjun Kwak, Portland, OR (US); Dae Won Lee, Portland, OR (US); Seung Hee Han, San Jose, CA (US); Gregory V. Morozov, Nizhny Novgorod (RU); Ansab Ali, Hillsboro, OR (US)

(21) Appl. No.: 16/473,382

(22) PCT Filed: Mar. 22, 2018
(86) PCT No.: PCT/US2018/023736

§ 371 Date: Jun. 25, 2019

Related U.S. Application Data
(60) Provisional application No. 62/475,776, filed on Mar. 23, 2017.
(60) Provisional application No. 62/588,252, filed on Nov. 17, 2017.

(51) Int. Cl. H04W 74/08; H04B 7/06; H04B 7/08; H04W 74/00

(52) U.S. Cl. CPC H04W 74/0841; H04B 7/0695; H04B 7/0617; H04W 74/004; H04B 7/088

(57) ABSTRACT

Techniques discussed herein can facilitate configuration and/or multi-beam operation of a NR (New Radio) PRACH (Physical Random Access Channel). One example embodiment employable at a UE (User Equipment) comprises processing circuitry configured to process higher layer signaling indicating a NR (New Radio) random access configuration; generate a random access preamble sequence based at least in part on the random access configuration; map the random access preamble sequence to a set of resources for each of a plurality of sets of beamforming weights; process N RARs (Random Access Responses) associated with the random access preamble sequence, wherein N is an integer greater than one; generate a random access Msg3 (message 3); and map N copies of the random access Msg3 to a PUSCH (Physical Uplink Shared Channel).

### REFERENCE TO RELATED APPLICATIONS

This application claims the benefit of U.S. Provisional Patent Applications No. 62/475,776 filed Mar. 23, 2017, entitled “PHYSICAL RANDOM ACCESS CHANNEL (PRACH) OPERATION FOR MULTI-BEAM SCENARIO” and 62/588,252 filed Nov. 17, 2017, entitled “MECHANISMS ON CONFIGURING PHYSICAL RANDOM ACCESS CHANNEL”, the contents of which are herein incorporated by reference in their entirety.

### FIELD

The present disclosure relates to wireless technology, and more specifically to techniques for configuration and/or multi-beam operation of a PRACH (Physical Random Access Channel).

### BACKGROUND

Mobile communication has evolved significantly from early voice systems to today's highly sophisticated integrated communication platform. The next generation wireless communication system, 5G (or new radio (NR)) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP (Third Generation Partnership Project) LTE (Long Term Evolution)-Advanced with additional potential new Radio Access Technologies (RATs) to enrich people lives with better, simple and seamless wireless connectivity solutions. NR will enable everything connected by wireless and deliver fast, rich contents and services.

### BRIEF DESCRIPTION OF THE DRAWINGS

FIG. 1 is a block diagram illustrating an example user equipment (UE) useable in connection with various aspects described herein.

FIG. 2 is a diagram illustrating example components of a device that can be employed in accordance with various aspects discussed herein.

FIG. 3 is a diagram illustrating example interfaces of baseband circuitry that can be employed in accordance with various aspects discussed herein.

FIG. 4 is a block diagram illustrating a system employable at a UE (User Equipment) that facilitates configuration of a PRACH (Physical Random Access Channel) and/or multi-beam PRACH operation, according to various aspects described herein.

FIG. 5 is a block diagram illustrating a system employable at a BS (Base Station) that facilitates configuration of a PRACH (Physical Random Access Channel) and/or multi-beam PRACH operation, according to various aspects described herein.

FIG. 6 is a diagram illustrating an initial access procedure, in connection with various aspects discussed herein.

FIG. 7 is a diagram illustrating an example resource mapping between synchronization signals and PRACH resources, for a PRACH procedure without gNB (next generation NodeB) correspondence, according to various aspects discussed herein.

FIG. 8 is a diagram illustrating an example Msg2 (Message 2) comprising multiple RARs (Random Access Responses), according to various aspects discussed herein.

FIG. 9 is a diagram illustrating an example scenario wherein PRACH resource subsets are divided in the frequency domain and/or code domain, according to various aspects discussed herein.

FIG. 10 is a diagram illustrating a pair of tables showing PRACH formats for long sequence length (L=839) and short sequence length (L=139) at the top and bottom, respectively, in connection with various aspects discussed herein.

FIG. 11 is a diagram illustrating an example transmission of SSB (Synchronization Signal Block) for up to 8 beams with a subcarrier spacing for SSB of 15 kHz, in connection with various aspects discussed herein.

FIG. 12 is a diagram illustrating an example transmission of SSB (Synchronization Signal Block) for up to 8 beams with a subcarrier spacing for SSB of 30 kHz, in connection with various aspects discussed herein.

FIG. 13 is a diagram illustrating one example of a PRACH configuration table having different parameters based on the half frame bit, according to various aspects discussed herein.

FIG. 14 is a diagram illustrating an example PRACH resource configuration, according to various aspects discussed herein.

FIG. 15 is a diagram illustrating different configurations for a short PRACH sequence including common configurations for formats A2, A3, and B4 regardless of starting symbol, according to various aspects discussed herein.

FIG. 16 is a diagram illustrating different configurations for a short PRACH sequence including different configurations for formats A2, A3, and B4 depending on starting symbol, according to various aspects discussed herein.

FIG. 17 is a diagram illustrating an example of a first option for applying PRACH configurations for different subcarrier spacings, according to various aspects discussed herein.

FIG. 18 is a diagram illustrating an example of a second option for applying PRACH configurations for different subcarrier spacings, according to various aspects discussed herein.

FIG. 19 is a diagram illustrating an example of a third option for applying PRACH configurations for different subcarrier spacings, according to various aspects discussed herein.

FIG. 20 is a flow diagram of an example method employable at a UE that facilitates multi-beam operation of a NR (New Radio) PRACH (Physical Random Access Channel), according to various aspects discussed herein.

FIG. 21 is a flow diagram of an example method employable at a BS that facilitates multi-beam operation of a NR (New Radio) PRACH (Physical Random Access Channel), according to various aspects discussed herein.

FIG. 22 is a flow diagram of an example method employable at a UE that facilitates configuration of a NR (New Radio) PRACH (Physical Random Access Channel), according to various aspects discussed herein.

FIG. 23 is a flow diagram of an example method employable at a BS that facilitates configuration of a NR (New Radio) PRACH (Physical Random Access Channel), according to various aspects discussed herein.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

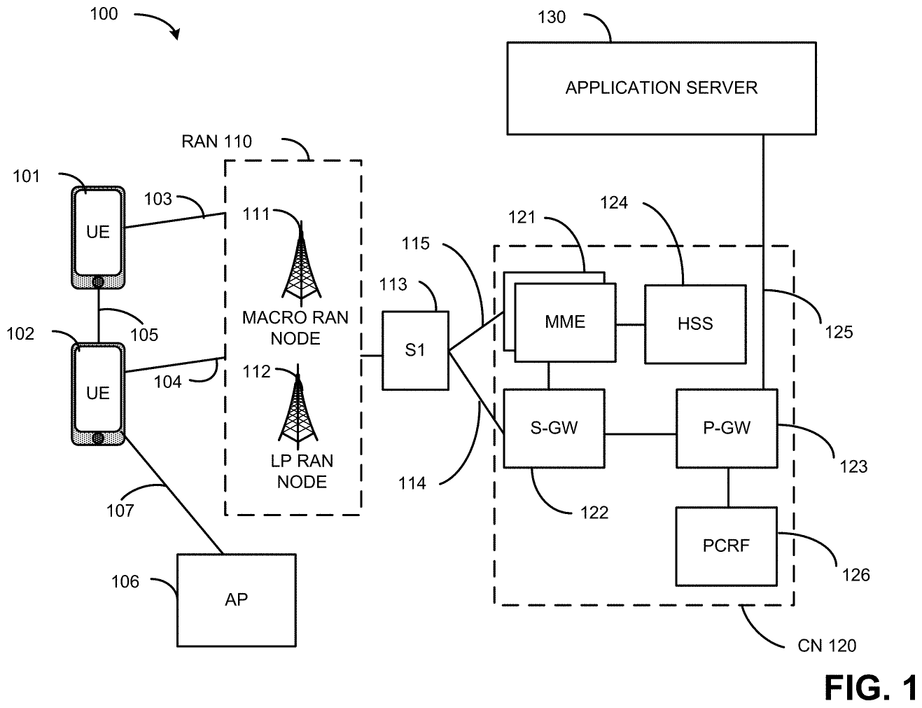

Embodiments described herein may be implemented into a system using any suitably configured hardware and/or software. FIG. 1 illustrates an architecture of a system 100 of a network in accordance with some embodiments. The system 100 is shown to include a user equipment (UE) 101 and a UE 102. The UEs 101 and 102 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 101 and 102 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 101 and 102 may be configured to connect, e.g., communicatively couple, with a radio access network (RAN) 110—the RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as a connection consistent with any IEEE 802.11 protocol, wherein the AP 106 would comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management.

In accordance with some embodiments, the UEs 101 and 102 can be configured to communicate using Orthogonal Frequency-Division Multiplexing (OFDM) communication signals with each other or with any of the RAN nodes 111 and 112 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 111 and 112 to the UEs 101 and 102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 101 and 102. The physical downlink control channel (PDCCH) may carry information about the transport format and resource allocations related to the PDSCH channel, among other things. It may also inform the UEs 101 and 102 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 111 and 112 based on channel quality information fed back from any of the UEs 101 and 102. The downlink resource assignment information may be sent on the PDCCH used for (e.g., assigned to) each of the UEs 101 and 102.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, 8, or 16).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 110 is shown to be communicatively coupled to a core network (CN) 120—via an S1 interface 113. In embodiments, the CN 120 may be an evolved packet core (EPC) network, a NextGen Packet Core (NPC) network, or some other type of CN. In this embodiment the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this embodiment, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities may include lawful intercept, charging, and some policy enforcement.

The P-GW 123 may terminate an SGi interface toward a PDN. The P-GW 123 may route data packets between the EPC network 123 and external networks such as a network including the application server 130 (alternatively referred to as application function (AF)) via an Internet Protocol (IP) interface 125. Generally, the application server 130 may be an element offering applications that use IP bearer resources with the core network (e.g., UMTS Packet Services (PS) domain, LTE PS data services, etc.). In this embodiment, the P-GW 123 is shown to be communicatively coupled to an application server 130 via an IP communications interface 125. The application server 130 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Enforcement Function (PCRF) 126 is the policy and charging control element of the CN 120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 may be communicatively coupled to the application server 130 via the P-GW 123. The application server 130 may signal the PCRF 126 to indicate a new service flow and select the appropriate Quality of Service (QoS) and charging parameters. The PCRF 126 may provision this rule into a Policy and Charging Enforcement Function (PCEF) (not shown) with the appropriate traffic flow template (TFT) and QoS class of identifier (QCI), which commences the QoS and charging as specified by the application server 130.

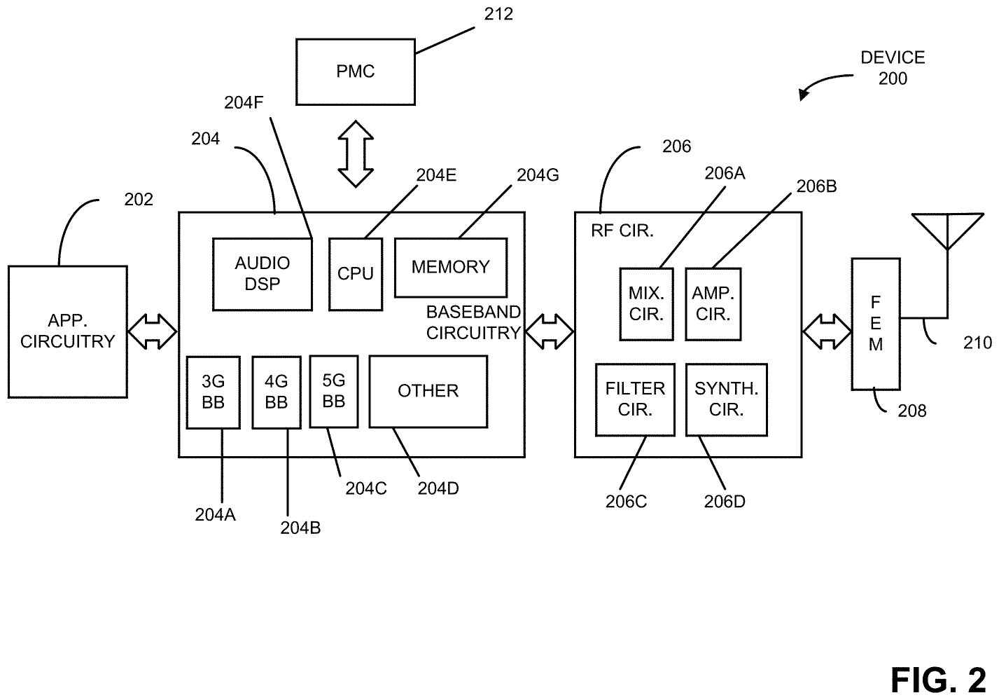

FIG. 2 illustrates example components of a device 200 in accordance with some embodiments. In some embodiments, the device 200 may include application circuitry 202, baseband circuitry 204, Radio Frequency (RF) circuitry 206, front-end module (FEM) circuitry 208, one or more antennas 210, and power management circuitry (PMC) 212 coupled together at least as shown. The components of the illustrated device 200 may be included in a UE or a RAN node. In some embodiments, the device 200 may include less elements (e.g., a RAN node may not utilize application circuitry 202, and instead include a processor/controller to process IP data received from an EPC). In some embodiments, the device 200 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 202 may include one or more application processors. For example, the application circuitry 202 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 200. In some embodiments, processors of application circuitry 202 may process IP data packets received from an EPC.

The baseband circuitry 204 may include circuitry such as, but not limited to, one or more single-core or multi-core processors. The baseband circuitry 204 may include one or more baseband processors or control logic to process baseband signals received from a receive signal path of the RF circuitry 206 and to generate baseband signals for a transmit signal path of the RF circuitry 206. Baseband processing circuitry 204 may interface with the application circuitry 202 for generation and processing of the baseband signals and for controlling operations of the RF circuitry 206. For example, in some embodiments, the baseband circuitry 204 may include a third generation (3G) baseband processor 204A, a fourth generation (4G) baseband processor 204B, a fifth generation (5G) baseband processor 204C, or other baseband processor(s) 204D for other existing generations, generations in development or to be developed in the future (e.g., second generation (2G), sixth generation (6G), etc.). The baseband circuitry 204 (e.g., one or more of baseband processors 204A-D) may handle various radio control functions that enable communication with one or more radio networks via the RF circuitry 206. In other embodiments, some or all of the functionality of baseband processors 204A-D may be included in modules stored in the memory 204G and executed via a Central Processing Unit (CPU) 204E. The radio control functions may include, but are not limited to, signal modulation/demodulation, encoding/decoding, radio frequency shifting, etc. In some embodiments, modulation/demodulation circuitry of the baseband circuitry 204 may include Fast-Fourier Transform (FFT), precoding, or constellation mapping/demapping functionality. In some embodiments, encoding/decoding circuitry of the baseband circuitry 204 may include convolution, tailbiting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 204 may include one or more audio digital signal processor(s) (DSP) 204F. The audio DSP(s) 204F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 204 and the application circuitry 202 may be implemented together such as, for example, on a system on a chip (SOC).

In some embodiments, the baseband circuitry 204 may provide for communication compatible with one or more radio technologies. For example, in some embodiments, the baseband circuitry 204 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 204 is configured to support radio communications of more than one wireless protocol may be referred to as multi-mode baseband circuitry.

RF circuitry 206 may enable communication with wireless networks using modulated electromagnetic radiation through a non-solid medium. In various embodiments, the RF circuitry 206 may include switches, filters, amplifiers, etc. to facilitate the communication with the wireless network. RF circuitry 206 may include a receive signal path which may include circuitry to down-convert RF signals received from the FEM circuitry 208 and provide baseband signals to the baseband circuitry 204. RF circuitry 206 may also include a transmit signal path which may include circuitry to up-convert baseband signals provided by the baseband circuitry 204 and provide RF output signals to the FEM circuitry 208 for transmission.

In some embodiments, the receive signal path of the RF circuitry 206 may include mixer circuitry 206a, amplifier circuitry 206b and filter circuitry 206c. In some embodiments, the transmit signal path of the RF circuitry 206 may include filter circuitry 206c and mixer circuitry 206a. RF circuitry 206 may also include synthesizer circuitry 206d for synthesizing a frequency for use by the mixer circuitry 206a of the receive signal path and the transmit signal path. In some embodiments, the mixer circuitry 206a of the receive signal path may be configured to down-convert RF signals received from the FEM circuitry 208 based on the synthesized frequency provided by synthesizer circuitry 206d. The amplifier circuitry 206b may be configured to amplify the down-converted signals and the filter circuitry 206c may be a low-pass filter (LPF) or band-pass filter (BPF) configured to remove unwanted signals from the down-converted signals to generate output baseband signals. Output baseband signals may be provided to the baseband circuitry 204 for further processing. In some embodiments, the output baseband signals may be zero-frequency baseband signals, although this is not a requirement. In some embodiments, mixer circuitry 206a of the receive signal path may comprise passive mixers, although the scope of the embodiments is not limited in this respect.

In some embodiments, the mixer circuitry 206a of the transmit signal path may be configured to up-convert input baseband signals based on the synthesized frequency provided by the synthesizer circuitry 206d to generate RF output signals for the FEM circuitry 208. The baseband signals may be provided by the baseband circuitry 204 and may be filtered by filter circuitry 206c.

In some embodiments, the mixer circuitry 206a of the receive signal path and the mixer circuitry 206a of the transmit signal path may include two or more mixers and may be arranged for quadrature downconversion and upconversion, respectively. In some embodiments, the mixer circuitry 206a of the receive signal path and the mixer circuitry 206a of the transmit signal path may include two or more mixers and may be arranged for image rejection (e.g., Hartley image rejection). In some embodiments, the mixer circuitry 206a of the receive signal path and the mixer circuitry 206a may be arranged for direct downconversion and direct upconversion, respectively. In some embodiments, the mixer circuitry 206a of the receive signal path and the mixer circuitry 206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 206 may include analog-to-digital converter (ADC) and digital-to-analog converter (DAC) circuitry and the baseband circuitry 204 may include a digital baseband interface to communicate with the RF circuitry 206.

In some dual-mode embodiments, a separate radio IC circuitry may be provided for processing signals for each spectrum, although the scope of the embodiments is not limited in this respect.

In some embodiments, the synthesizer circuitry 206d may be a fractional-N synthesizer or a fractional N/N+1 synthesizer, although the scope of the embodiments is not limited in this respect as other types of frequency synthesizers may be suitable. For example, synthesizer circuitry 206d may be a delta-sigma synthesizer, a frequency multiplier, or a synthesizer comprising a phase-locked loop with a frequency divider.

The synthesizer circuitry 206d may be configured to synthesize an output frequency for use by the mixer circuitry 206a of the RF circuitry 206 based on a frequency input and a divider control input. In some embodiments, the synthesizer circuitry 206d may be a fractional N/N+1 synthesizer.

In some embodiments, frequency input may be provided by a voltage controlled oscillator (VCO), although that is not a requirement. Divider control input may be provided by either the baseband circuitry 204 or the applications processor 202 depending on the desired output frequency. In some embodiments, a divider control input (e.g., N) may be determined from a look-up table based on a channel indicated by the applications processor 202.

Synthesizer circuitry 206d of the RF circuitry 206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 206 may include an IQ/polar converter.

FEM circuitry 208 may include a receive signal path which may include circuitry configured to operate on RF signals received from one or more antennas 210, amplify the received signals and provide the amplified versions of the received signals to the RF circuitry 206 for further processing. FEM circuitry 208 may also include a transmit signal path which may include circuitry configured to amplify signals for transmission provided by the RF circuitry 206 for transmission by one or more of the one or more antennas 210. In various embodiments, the amplification through the transmit or receive signal paths may be done solely in the RF circuitry 206, solely in the FEM 208, or in both the RF circuitry 206 and the FEM 208.

In some embodiments, the FEM circuitry 208 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 206). The transmit signal path of the FEM circuitry 208 may include a power amplifier (PA) to amplify input RF signals (e.g., provided by RF circuitry 206), and one or more filters to generate RF signals for subsequent transmission (e.g., by one or more of the one or more antennas 210).

In some embodiments, the PMC 212 may manage power provided to the baseband circuitry 204. In particular, the PMC 212 may control power-source selection, voltage scaling, battery charging, or DC-to-DC conversion. The PMC 212 may often be included when the device 200 is capable of being powered by a battery, for example, when the device is included in a UE. The PMC 212 may increase the power conversion efficiency while providing desirable implementation size and heat dissipation characteristics.

While FIG. 2 shows the PMC 212 coupled only with the baseband circuitry 204. However, in other embodiments, the PMC 212 may be additionally or alternatively coupled with, and perform similar power management operations for, other components such as, but not limited to, application circuitry 202, RF circuitry 206, or FEM 208.

In some embodiments, the PMC 212 may control, or otherwise be part of, various power saving mechanisms of the device 200. For example, if the device 200 is in an RRC_Connected state, where it is still connected to the RAN node as it expects to receive traffic shortly, then it may enter a state known as Discontinuous Reception Mode (DRX) after a period of inactivity. During this state, the device 200 may power down for brief intervals of time and thus save power.

If there is no data traffic activity for an extended period of time, then the device 200 may transition off to an RRC_Idle state, where it disconnects from the network and does not perform operations such as channel quality feedback, handover, etc. The device 200 goes into a very low power state and it performs paging where again it periodically wakes up to listen to the network and then powers down again. The device 200 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 202 and processors of the baseband circuitry 204 may be used to execute elements of one or more instances of a protocol stack. For example, processors of the baseband circuitry 204, alone or in combination, may be used execute Layer 3, Layer 2, or Layer 1 functionality, while processors of the application circuitry 204 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

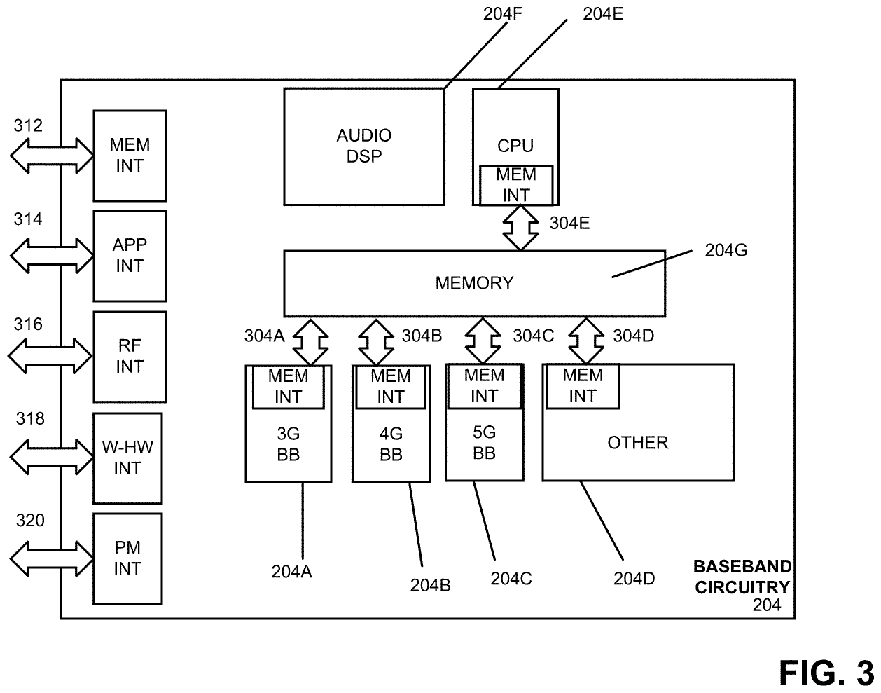

FIG. 3 illustrates example interfaces of baseband circuitry in accordance with some embodiments. As discussed above, the baseband circuitry 204 of FIG. 2 may comprise processors 204A-204E and a memory 204G utilized by said processors. Each of the processors 204A-204E may include a memory interface, 304A-304E, respectively, to send/receive data to/from the memory 204G.

The baseband circuitry 204 may further include one or more interfaces to communicatively couple to other circuitries/devices, such as a memory interface 312 (e.g., an interface to send/receive data to/from memory external to the baseband circuitry 204), an application circuitry interface 314 (e.g., an interface to send/receive data to/from the application circuitry 202 of FIG. 2), an RF circuitry interface 316 (e.g., an interface to send/receive data to/from RF circuitry 206 of FIG. 2), a wireless hardware connectivity interface 318 (e.g., an interface to send/receive data to/from Near Field Communication (NFC) components, Bluetooth® components (e.g., Bluetooth® Low Energy), Wi-Fi® components, and other communication components), and a power management interface 320 (e.g., an interface to send/receive power or control signals to/from the PMC 212).

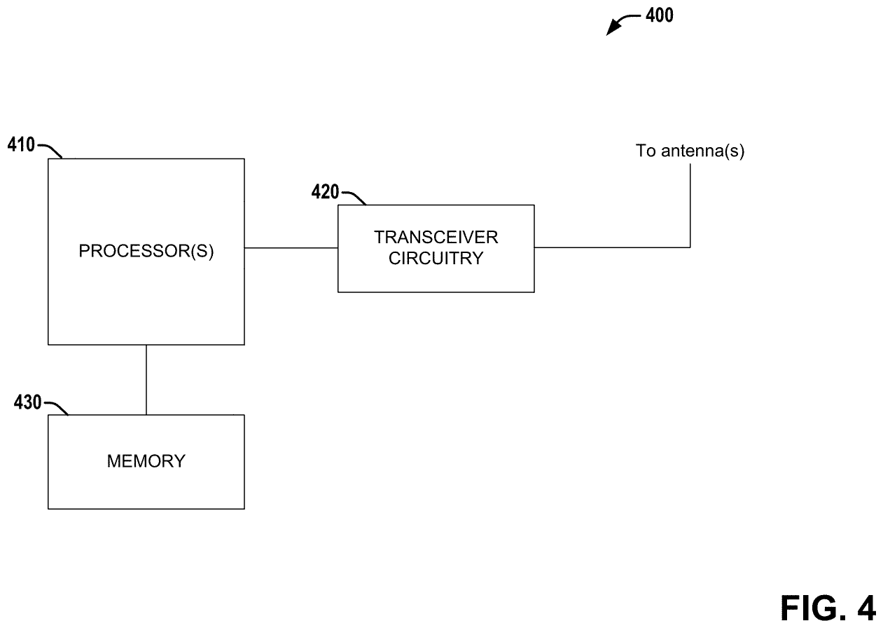

Referring to FIG. 4, illustrated is a block diagram of a system 400 employable at a UE (User Equipment) that facilitates configuration of a PRACH (Physical Random Access Channel) and/or multi-beam PRACH operation, according to various aspects described herein. System 400 can include one or more processors 410 (e.g., one or more baseband processors such as one or more of the baseband processors discussed in connection with FIG. 2 and/or FIG. 3) comprising processing circuitry and associated interface(s) (e.g., one or more interface(s) discussed in connection with FIG. 3), transceiver circuitry 420 (e.g., comprising part or all of RF circuitry 206, which can comprise transmitter circuitry (e.g., associated with one or more transmit chains) and/or receiver circuitry (e.g., associated with one or more receive chains) that can employ common circuit elements, distinct circuit elements, or a combination thereof), and a memory 430 (which can comprise any of a variety of storage mediums and can store instructions and/or data associated with one or more of processor(s) 410 or transceiver circuitry 420). In various aspects, system 400 can be included within a user equipment (UE). As described in greater detail below, system 400 can facilitate configuration of a NR PRACH and/or initial access to a network via NR PRACH.

In various aspects discussed herein, signals and/or messages can be generated and output for transmission, and/or transmitted messages can be received and processed. Depending on the type of signal or message generated, outputting for transmission (e.g., by processor(s) 410, processor(s) 510, etc.) can comprise one or more of the following: generating a set of associated bits that indicate the content of the signal or message, coding (e.g., which can include adding a cyclic redundancy check (CRC) and/or coding via one or more of turbo code, low density parity-check (LDPC) code, tailbiting convolution code (TBCC), etc.), scrambling (e.g., based on a scrambling seed), modulating (e.g., via one of binary phase shift keying (BPSK), quadrature phase shift keying (QPSK), or some form of quadrature amplitude modulation (QAM), etc.), and/or resource mapping (e.g., to a scheduled set of resources, to a set of time and frequency resources granted for uplink transmission, etc.). Depending on the type of received signal or message, processing (e.g., by processor(s) 410, processor(s) 510, etc.) can comprise one or more of: identifying physical resources associated with the signal/message, detecting the signal/message, resource element group deinterleaving, demodulation, descrambling, and/or decoding.

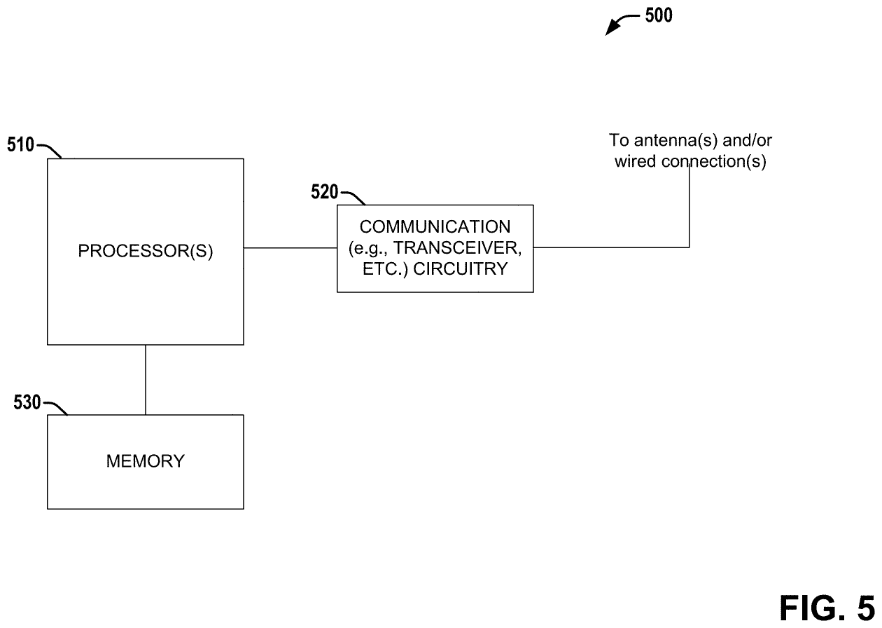

Referring to FIG. 5, illustrated is a block diagram of a system 500 employable at a BS (Base Station) that facilitates configuration of a PRACH (Physical Random Access Channel) and/or multi-beam PRACH operation, according to various aspects described herein. System 500 can include one or more processors 510 (e.g., one or more baseband processors such as one or more of the baseband processors discussed in connection with FIG. 2 and/or FIG. 3) comprising processing circuitry and associated interface(s) (e.g., one or more interface(s) discussed in connection with FIG. 3), communication circuitry 520 (e.g., which can comprise circuitry for one or more wired (e.g., X2, etc.) connections and/or part or all of RF circuitry 206, which can comprise one or more of transmitter circuitry (e.g., associated with one or more transmit chains) or receiver circuitry (e.g., associated with one or more receive chains), wherein the transmitter circuitry and receiver circuitry can employ common circuit elements, distinct circuit elements, or a combination thereof), and memory 530 (which can comprise any of a variety of storage mediums and can store instructions and/or data associated with one or more of processor(s) 510 or communication circuitry 520). In various aspects, system 500 can be included within an Evolved Universal Terrestrial Radio Access Network (E-UTRAN) Node B (Evolved Node B, eNodeB, or eNB), next generation Node B (gNodeB or gNB) or other base station or TRP (Transmit/Receive Point) in a wireless communications network. In some aspects, the processor(s) 510, communication circuitry 520, and the memory 530 can be included in a single device, while in other aspects, they can be included in different devices, such as part of a distributed architecture. As described in greater detail below, system 500 can facilitate configuration of a NR PRACH and/or initial access to a network via NR PRACH for one or more UEs.

### PRACH (Physical Random Access Channel) Operation for Multi-Beam Scenarios

At the 3GPP RAN1 (RAN (Radio Access Network) WG1 (Working Group 1) #88 meeting in February 2017, the following agreements were made with regard to NR random access:
For contention-free random access, the following options are under evaluation
Option 1: Transmission of only a single Msg.1 [Message 1] before the end of a monitored RAR [Random Access Request] window
Option 2: A UE can be configured to transmit multiple simultaneous Msg.1
   Note: multiple simultaneous Msg.1 transmissions use different frequency resources and/or use the same frequency resource with different preamble indices
Option 3: A UE can be configured to transmit multiple Msg.1 over multiple RACH [Random Access Channel] transmission occasions in the time domain before the end of a monitored RAR window
Following is baseline UE behavior
   UE assumes single RAR reception at a UE within a given RAR window
NR random access design should not preclude UE reception of multiple RAR within a given RAR window, if need arises
At least for the case without gNB [next generation NodeB] Tx [Transmit]/Rx [Receive] beam correspondence, gNB can configure an association between DL [Downlink] signal/channel, and a subset of RACH resources and/or a subset of preamble indices, for determining Msg2 DL Tx beam.
Based on the DL measurement and the corresponding association, UE selects the subset of RACH resources and/or the subset of RACH preamble indices
A preamble index consists of preamble sequence index and OCC [Orthogonal Cover Code] index, if OCC is supported
   Note: a subset of preambles can be indicated by OCC indices

For a random access procedure (especially for multi-beam scenarios), depending on the beam correspondence at the BS (e.g., gNB) and/or UE side, resource allocation for the PRACH preamble and the relevant RAR (Random Access Response) could be different. If there is no beam correspondence, there can be some ambiguous operations (e.g., performed by processor(s) 510 and/or communication circuitry 520) at the gNB side during Rx beam management. When a BS (e.g., gNB) performs Rx beam sweeping (e.g., by processor(s) 510 and/or communication circuitry 520) for the detection of PRACH preamble, it is possible the BS (e.g., gNB) can detect (e.g., via processor(s) 510 and/or communication circuitry 520) the same sequence in different Rx beams and not differentiate between whether the detected sequences (e.g., generated by respective processor(s) 510, transmitted via respective communication circuitry 520, received via transceiver circuitry 420, and processed by processor(s) 410) using different Rx beams (e.g., formed via communication circuitry 520 applying associated beamforming weights selected by processor(s) 510) are transmitted from the same UE or different UEs.

In various embodiments employing a first set of aspects (e.g., related to PRACH operation for multi-beam scenarios) discussed herein, techniques can be employed that can resolve ambiguities between scenarios wherein detected sequences using different Rx beams are transmitted from the same UE or different UEs.

### Mechanisms to Perform Random Access Procedure for Multi-Beam Scenarios

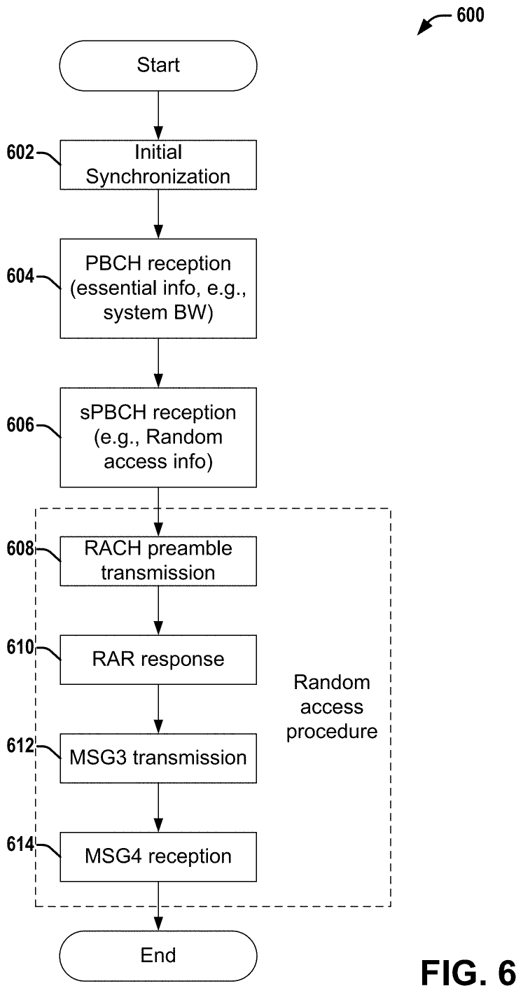

Referring to FIG. 6, illustrated is a diagram showing an initial access procedure 600, in connection with various aspects discussed herein. When a UE starts the initial access, it can first perform initial synchronization by detecting (e.g., via processor(s) 410 and transceiver circuitry 420) synchronization signals (at 602) and can sequentially receive (e.g., via transceiver circuitry 420) PBCH (Physical Broadcast Channel) (at 604) to obtain the most essential system information, and can receives sPBCH (at 606) to obtain (e.g., via transceiver circuitry 420) at least random access procedure configuration information. For the random access procedure, the UE can transmit (e.g., via transceiver circuitry 420) the PRACH preamble (Msg1 (Message 1)) (e.g., generated by processor(s) 410) using the configured resources (at 608). At 610, a random access response (Msg2) can be transmitted (e.g., via communication circuitry 520) from the BS (e.g., gNB) when it detects (e.g., via communication circuitry 520 and processor(s) 510) the preamble (e.g., generated by processor(s) 410, transmitted via transceiver circuitry 420, received via communication circuitry 520, and processed by processor(s) 510). At 612, the UE can transmit Msg3 (e.g., wherein Msg3 can be generated by processor(s) 410, transmitted via transceiver circuitry 420 (e.g., over NR (New Radio) PUSCH (Physical Uplink Shared Channel)), received via communication circuitry 520, and processed by processor(s) 510), which can comprise ID (Identification) information and other UE status information. At 614, the BS (e.g., gNB) can transmit Msg4 (e.g., generated by processor(s) 510, transmitted via communication circuitry 520, received via transceiver circuitry 420, and processed by processor(s) 410) for collision resolution, after which the initial access procedure finishes.

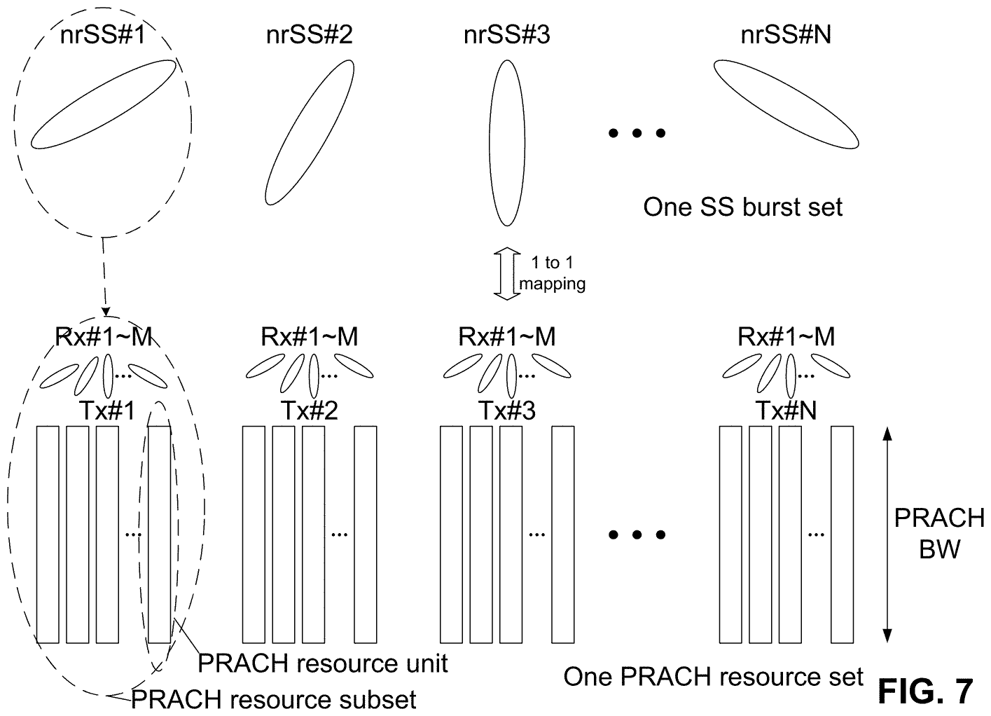

In a multi-beam system, if there is no Tx/Rx beam correspondence in the NR base station (e.g., gNB), the PRACH resource set can be configured (e.g., via configuration signaling generated by processor(s) 510, transmitted via communication circuitry 520, received via transceiver circuitry 420, and processed by processor(s) 410) according to the number of beams (say ‘N’) for the synchronization signals (SS blocks) in a synchronization period (SS burst set). Referring to FIG. 7, illustrated is a diagram of an example resource mapping between synchronization signals and PRACH resources, for a PRACH procedure without gNB correspondence, according to various aspects discussed herein. In various embodiments implementing the first set of aspects, the PRACH resource set can be divided into N separate PRACH resource subsets, as shown in FIG. 7. Note that the example illustrated in FIG. 7 is just one example resource mapping between synchronization signal and PRACH resources. In various embodiments, the synchronization signal index can be defined in multiple different ways. In various embodiments, a time index for the synchronization signal can be employed (e.g., by processor(s) 410 and/or processor(s) 510) as the synchronization signal index.

In various embodiments, multiple aspects can be varied for indexing synchronization signals (e.g., generated by processor(s) 510, transmitted via communication circuitry 520, received via transceiver circuitry 420, and processed by processor(s) 410). In embodiments implementing the first set of aspects, the set of possible SS (Synchronization Signal) block time locations can be defined in a variety of ways, which can differ from other embodiments based on one or more of the following aspects: (1) Whether or not a SS block comprises consecutive symbols and/or whether or not SS and PBCH (e.g., generated by processor(s) 510) are transmitted (e.g., via communication circuitry 520) in the same or different slots; (2) Number of symbols per SS block; (3) Whether or not to map across slot boundary(ies); (4) Whether or not to skip symbol(s) within a slot or a slot set; (5) With respect to the contents of an SS block; and/or (6) How SS blocks are arranged within a burst set, and/or the number of SS blocks per burst/burst set.

Inside one PRACH resource subset, there can be multiple PRACH resource units (e.g., as illustrated in the example of FIG. 7). In various embodiments, for the indication of a best Tx beam for a UE to the BS (e.g., gNB), there can be a one-to-one mapping between the SS block index and PRACH resource subset index. In various such embodiments, the SS block index can be one of the time index of the SS block, the Tx beam index of the SS block, the resource index of SS block, or another possible index for the expression of SS block. The UE can select (e.g., via processor(s) 410) the PRACH resource subset which corresponds to the best gNB Tx beam index for the UE (e.g., as determined by processor(s) 410 based on SS received via transceiver circuitry 420 from one or more Tx beams) for indication of the best Tx beam to the BS (e.g., gNB). For determination of the best beam pair, the UE can also receive SS burst sets (e.g., generated by processor(s) 510, transmitted via communication circuitry 520, received via transceiver circuitry 420, and processed by processor(s) 410) multiple times using different UE Rx beams and can determine (e.g., via processor(s) 410) the best gNB Tx beam and the best UE Rx beam pair.

In various embodiments of the first set of aspects, as shown in the lower portion of FIG. 7, a UE can transmit (e.g., via transceiver circuitry 420) preamble (e.g., generated by processor(s) 410) through all PRACH resource units inside one PRACH resource subset that was selected by the UE (e.g., via processor(s) 410). The PRACH preamble (e.g., generated by processor(s) 410) can be transmitted repeatedly (e.g., via transceiver circuitry 420) in order to cover the time duration of multiple PRACH resource units. The BS (e.g., gNB) can perform Rx beam sweeping (e.g., via processor(s) 510 and communication circuitry 520) inside each PRACH resource subset for detecting the preamble, since the BS (e.g., gNB) does not know which beam is the best Rx beam for each Tx beam.

In various scenarios, the BS (e.g., gNB) can detect (e.g., via processor(s) 510 and communication circuitry 520) the same preamble in different PRACH resource units inside a single PRACH resource subset. One possible scenario is that different UEs can transmit (e.g., via respective transceiver circuitries 420) the same PRACH preamble (e.g., generated by respective processor(s) 410) in the same PRACH resource subset but they are received via different Rx beams (e.g., via communication circuitry 520) of the BS (e.g., gNB). Another possible scenario is that only one UE transmits (e.g., via transceiver circuitry 420) the PRACH preamble (e.g., generated by processor(s) 410), but it is received by multiple Rx beams (e.g., via communication circuitry 520) of the BS (e.g., gNB). However, conventionally, the BS (e.g. gNB) does not know whether these preambles are received from one UE or multiple UEs. In various embodiments employing the first set of aspects, however, one or more techniques discussed herein can be employed to resolve this issue.

In some embodiments associated with the first set of aspects, the BS (e.g., gNB) can transmit (e.g., via communication circuitry 520) multiple RARs (e.g., generated by processor(s) 510) in order to resolve the ambiguity issues in detecting multiple preamble sequences (e.g., from one or more UEs).

In a first option for such embodiments, multiple RARs (e.g., generated by processor(s) 510) can be transmitted (e.g., via communication circuitry 520) using multiple Msg2 transmissions (e.g., generated by processor(s) 510), which means that separate PDCCH (Physical Downlink Control Channel) with the same RA (Random Access)-RNTI (Radio Network Temporary Identifier) can be transmitted for multiple RARs. The RA-RNTI can be derived (e.g., generated by processor(s) 510) from the PRACH resource where multiple preambles were detected by different Rx beams. In such embodiments, the UE can receive (e.g., via transceiver circuitry 520) multiple PDCCHs for the same RA-RNTI and relevant PDSCHs (Physical Downlink Shared Channels) for multiple Msg2's (e.g., generated by processor(s) 510, transmitted via communication circuitry 520, received via transceiver circuitry 420, and processed by processor(s) 410), as the UE does not know which Msg2 is for the UE. In such aspects, there are multiple options to define relevant UE behaviors: (1) The UE can select (e.g., via processor(s) 410) the first RAR that is correctly received (e.g., via transceiver circuitry 420) within the RAR window; (2) The UE can receive (e.g., via transceiver circuitry 420) all the RARs (corresponding to its Msg1 transmission) within the RAR window and can respond to all of those RARs in Msg3 (e.g., generated by processor(s) 410, transmitted via transceiver circuitry 420, received via communication circuitry 520, and processed by processor(s) 510); or (3) The UE can receive (e.g., via transceiver circuitry 420) all the RARs (corresponding to its Msg1 transmission) within the RAR window but can select (e.g., via processor(s) 410) only one of the RARs (e.g., randomly, the RAR with a largest Rx power, based on additional information in the RAR (e.g., preamble Rx power, etc.), etc.)

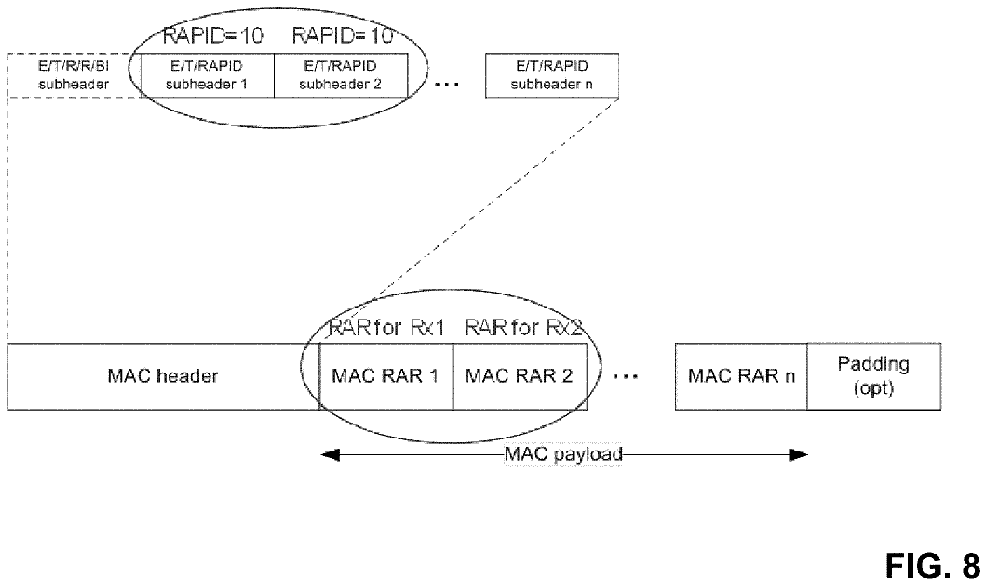

In a second option for such embodiments, multiple RARs (e.g., generated by processor(s) 510) can be transmitted (e.g., via communication circuitry 520) using one single Msg2 transmission (e.g., generated by processor(s) 510), which means that one PDCCH with the corresponding RA-RNTI (e.g., generated by processor(s) 510) can be transmitted (e.g., via communication circuitry 520) for multiple RARs. That RA-RNTI can be derived (e.g., via processor(s) 510) from the PRACH resource where multiple preamble were detected by different Rx beams. The BS (e.g., gNB) can transmit (e.g., via communication circuitry 520) one single Msg2 transmission (e.g., generated by processor(s) 510) with multiple RARs. Referring to FIG. 8, illustrated is a diagram showing an example Msg2 (Message 2) comprising multiple RARs (Random Access Responses), according to various aspects discussed herein. In such embodiments, multiple RARs (e.g., generated by processor(s) 510) can be multiplexed together (e.g., by processor(s) 510) in a RAR MAC (Medium Access Control) PDU (Protocol Data Unit) with the same preamble sequence (RAPID (Random Access Preamble Identifier)) for each RAR. The UE can just monitor (e.g., via processor(s) 410 and transceiver circuitry 420) one single PDCCH with the corresponding RA-RNTI and can receive (e.g., via transceiver circuitry 420) PDSCH (Physical Downlink Shared Channel) which conveys multiple RARs. If UE checks that there are multiple RAR with same RAPID but with different TA (Timing Advance) and/or UL grants in them, the UE can follow the RARs, thus the UE can transmit (e.g., via transceiver circuitry 420) Msg3 (e.g., generated by processor(s) 410) multiple times, according to the multiple RARs. For the reception (e.g., via communication circuitry 520) of multiple Msg3s, the BS (e.g., gNB) can use the different Rx beams that were used for the detection (e.g., via processor(s) 510 and communication circuitry 520) of Msg1. If the Msg1 was transmitted by multiple (e.g., 2, etc.) UEs (e.g., via respective transceiver circuitries 420), those UEs will transmit (e.g., via respective transceiver circuitries 420) Msg3 (e.g., generated by respective processor(s) 410) multiple (e.g., two) times according to the multiple (e.g., 2) RARs in the RAR MAC PDU (e.g., generated by processor(s) 510, transmitted via communication circuitry 520, received via transceiver circuitry 420, and processed by processor(s) 410). However, only one Msg3 of each UE will be received (e.g., via communication circuitry 520) by the two different Rx beams.

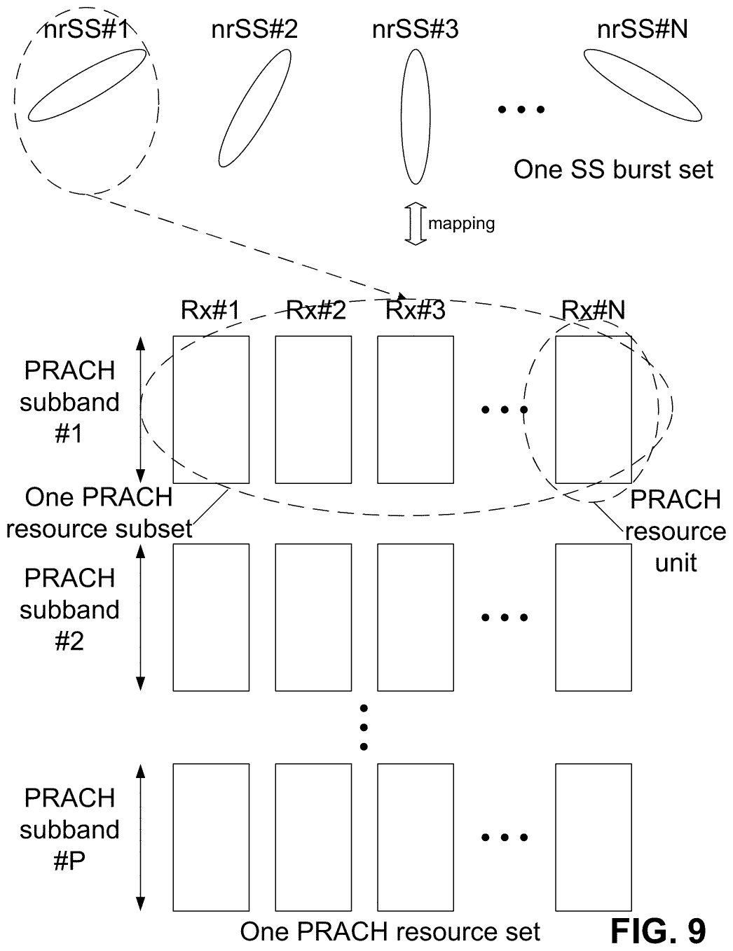

In other embodiments associated with the first set of aspects, there can be a different beam mapping between the Tx beam(s) for synchronization signal and PRACH resources. In various aspects, the PRACH resource set can be configured (e.g., via configuration signaling generated by processor(s) 510, transmitted via communication circuitry 520, received via transceiver circuitry 420, and processed by processor(s) 410) based on the number of beams (e.g., ‘N’) for the synchronization signals (SS blocks) in a synchronization period (SS burst set). Additionally, the PRACH resource set can be divided (e.g., via configuration signaling) into N separate PRACH resource subsets. The PRACH resource subsets can be divided in one or more of the time domain (as shown in FIG. 7), the frequency domain, and/or the code domain. Inside one PRACH resource subset, there can be multiple PRACH resource units for Rx beam sweeping. Referring to FIG. 9, illustrated is a diagram showing an example scenario wherein PRACH resource subsets are divided in the frequency domain and/or code domain, according to various aspects discussed herein.

In various embodiments, to indicate a best Tx beam for a UE to the BS (e.g., gNB), there can be one-to-one mapping between the SS block index and PRACH resource subset index. As discussed above, the PRACH resource subset can be divided in the frequency domain and/or code domain. Since there are a limited number of PRACH sequences inside one PRACH resource subset, there are a limited number of subsets inside the same resources. Thus, if the number of beams in the synchronization signals is larger than the maximum possible number of PRACH resource subsets sharing the same time-frequency resource, then there can be additional domain for mapping additional PRACH resource subsets. In various embodiments, the additional resource subsets can be configured in the frequency domain, as in the example illustrated in FIG. 9. One advantage of using the frequency domain rather than time domain is that the BS (e.g., gNB) can use the same Rx beam sweeping (e.g., via processor(s) 510 and communication circuitry 520) for multiple PRACH resource subsets. Additionally or alternatively, time-domain division of the PRACH resource subset can also be employed. Given that there are multiple domains for the division of PRACH resource subsets, the manner in which the Tx beams of SS block are multiplexed can be configured by the NW, for example, using higher layer signaling (e.g., generated by processor(s) 510, transmitted via communication circuitry 520, received via transceiver circuitry 420, and processed by processor(s) 410) such as SIB (System Information Block), NR RMSI (Remaining Minimum System Information), or NR OSI (Other System Information). This higher layer signaling can indicate one or more of the following in connection with the mapping between the SS block index and PRACH resource subset index: (1) Which domain is prioritized (e.g. code domain first, frequency domain second, and time domain third; or code domain first and frequency domain second; etc.); (2) how many PRACH resource subsets can be divided in the code domain (e.g., 8 codes for each PRACH resource subsets means there can be 8 PRACH resource subsets sharing the same time-frequency resources assuming total 64 sequences are possible) (configuration of the code domain); (3) how to configure the subband for each PRACH resource subsets (configuration of the frequency domain); (4) how to configure the slots for each PRACH resource subsets (configuration of the time domain); and/or other information; etc.

Depending on the PRACH resource subset configuration, the UE can choose (e.g., via processor(s) 410) the PRACH resource subset which corresponds to the best SS block index for the UE for the indication of best Tx beam to the BS (e.g., gNB).

In various embodiments employing the first set of aspects, a UE can be informed in the RAR of the corresponding UE Tx beam. The BS (e.g., gNB) can use RA-RNTI, where RA-RNTI can be RA-RNTI=1+t_id+10t_id, where t_id is the first subframe index of the PRACH slot. However, in various embodiments, RA-RNTI can be modified to cover all possible PRACH resource subset configurations, considering time domain, frequency domain and code domain. Thus, in various embodiments, RA-RNTI can be defined as a function of one or more of time, frequency, and/or code, RA-RNTI=f(t_id, f_id, c_id), where t_id is a timing index, f_id is a frequency index, and c_id is a code index.

In various embodiments, any of a variety of equations can be used for RA-RNTI generation. A first example for a RA-RNTI generating equation is RA-RNTI=M+PRSS_id+Q×PRSB_id, where PRSS_id is the PRACH resource subset index (0, 1, 2, . . . , Q−1), Q is the number of PRACH resource subset index, PRSB_id is the subband index of the PRACH resource set, and M is an integer number. A second example for a RA-RNTI generating equation is RA-RNTI=M+CD_id+P×PRSB_id, where CD_id is the ID for the Code group forming each PRACH resource subset (0, 1, 2, . . . , P−1), P is the number of maximum PRACH resource subsets sharing the same time-frequency resource index, PRSB_id is the subband index of the PRACH resource set, and M is an integer number (e.g., this generating equation can be used for PRACH resource subset division by code/frequency domain). A third example for a RA-RNTI generating equation is RA-RNTI=M+A×CD_id+B×PRSB_id+C×t_id, where CD_id is the ID for the code group forming each PRACH resource subset, PRSB_id is the subband index of the PRACH resource set, t_id is the time domain index of PRACH resource set, and A/B/C/M are integer numbers. In other embodiments, other generating equations can be employed.

In various embodiments, the UE can provide some information via Msg3 (e.g., generated by processor(s) 410, transmitted via transceiver circuitry 420, received via communication circuitry 520, and processed by processor(s) 510) on the gNB Tx beam for the transmission of Msg4 (e.g., generated by processor(s) 510, transmitted via communication circuitry 520, received via transceiver circuitry 420, and processed by processor(s) 410). Between the transmissions of Msg2 and Msg4 (e.g., via communication circuitry 520), there can be changes in the BS (e.g., gNB) best Tx beams, so information from the UE on the best BS (e.g., gNB) Tx beam can be beneficial for improving the Msg4 transmission (e.g., generated by processor(s) 510, transmitted via communication circuitry 520, received via transceiver circuitry 420, and processed by processor(s) 410). In various embodiments, the UE can include information indicating a best BS (e.g., gNB) Tx beam information inside the MAC (Medium Access Control) CE (Control Element) of the Msg3 (e.g., generated by processor(s) 410, transmitted via transceiver circuitry 420, received via communication circuitry 520, and processed by processor(s) 510).

### Mechanisms for Configuring PRACH (Physical Random Access Channel)

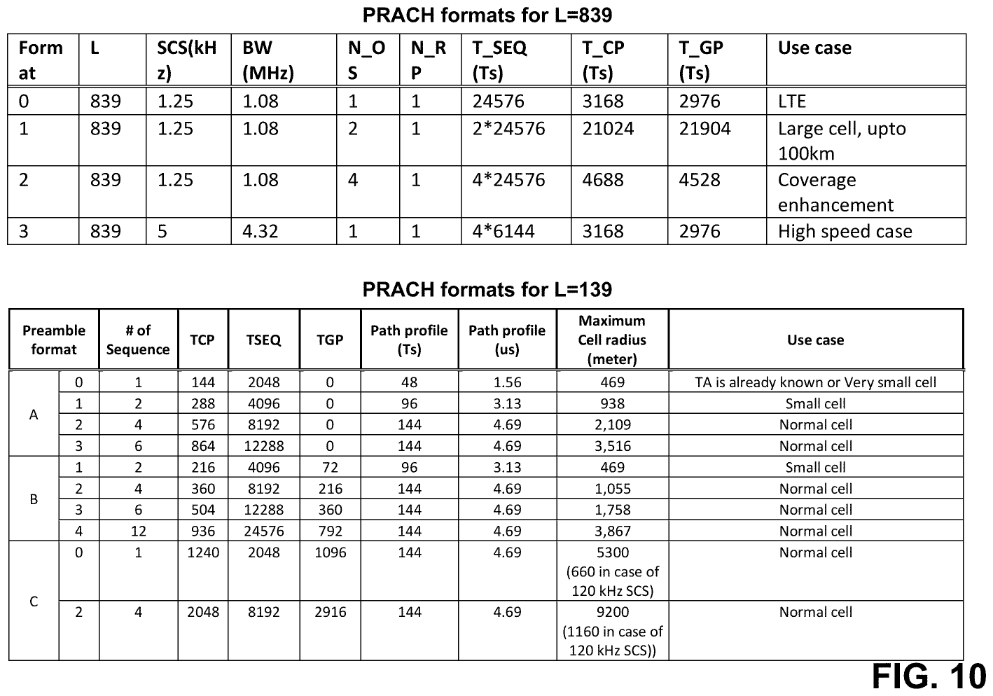

In the 3GPP RAN1 NR Ad Hoc meeting in June 2017 and the RAN1 meeting #90 in August 2017, Physical random access channel (PRACH) formats for long sequence length (L=839) and short sequence length (L=139) were agreed upon. Referring to FIG. 10, illustrated is a pair of tables showing PRACH formats for long sequence length (L=839) and short sequence length (L=139) at the top and bottom, respectively, in connection with various aspects discussed herein. As can be seen in FIG. 10, there are many formats for PRACH, and how to configure the PRACH in the time domain and the frequency domain is not clear. In various embodiments employing a second set of aspects, PRACH configuration methods discussed herein can be employed, which can provide a more efficient random access procedure than conventional systems.

PRACH configuration can facilitate performance of the random access procedure (e.g., by system 400 and system 500) for initial access to the network for a UE. In NR, PRACH related configuration can be indicated by remaining minimum system information (RMSI) which can be read (e.g., by processor(s) 410) after detecting (e.g., via transceiver circuitry 420 and processor(s) 410) the synchronization signal block (SSB slot) and physical broadcast channel (PBCH) (e.g., generated by processor(s) 510, transmitted via communication circuitry 520, received via transceiver circuitry 420, and processed by processor(s) 410).

For PRACH configuration, it is important to utilize the limited number of bits to have various kinds of PRACH configurations available to supporting various deployment scenario. Some example candidate scenarios can be a downlink heavy cell, an uplink heavy cell, a single beam scenario, a multi-beam scenario, a FDD system, a TDD system, etc.

A PRACH occasion is defined as the time-frequency resource on which a PRACH message 1 (e.g., random access preamble generated by processor(s) 410, and also referred to herein as Msg1, Msg-1 or Msg.1) can be transmitted (e.g., via transceiver circuitry 420) using the configured PRACH preamble format with a single particular Tx beam.

PRACH is sent via uplink transmission (e.g., generated by processor(s) 410, transmitted via transceiver circuitry 420, received via communication circuitry 520, and processed by processor(s) 510). Thus, scenarios involving collision between PRACH slots and downlink slots should be avoided. The slots which include the transmission (e.g., via communication circuitry 520) of synchronization signal block (SSB slot) (e.g., generated by processor(s) 510) are slots that cannot be changed from downlink to uplink. Therefore, the SSB slots should be avoided for the PRACH configuration.

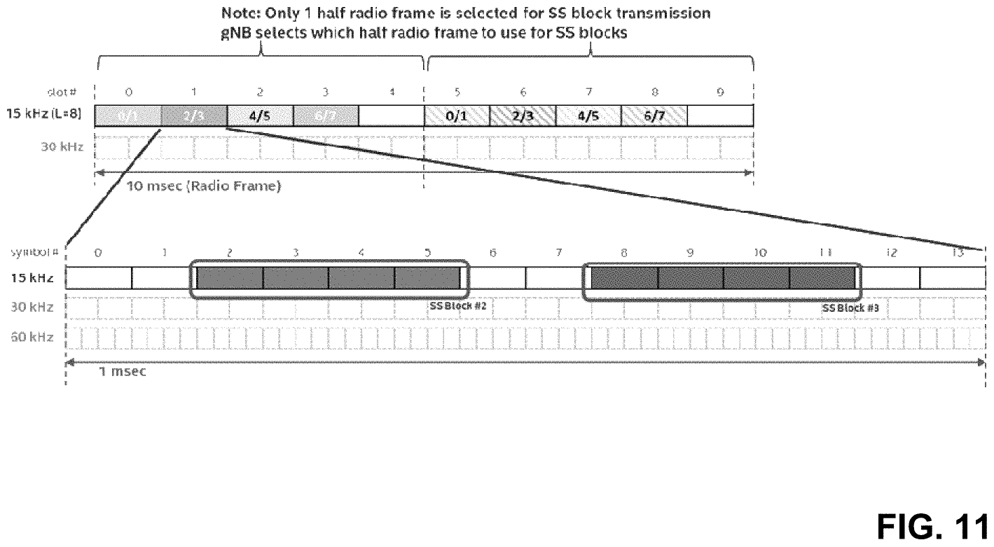

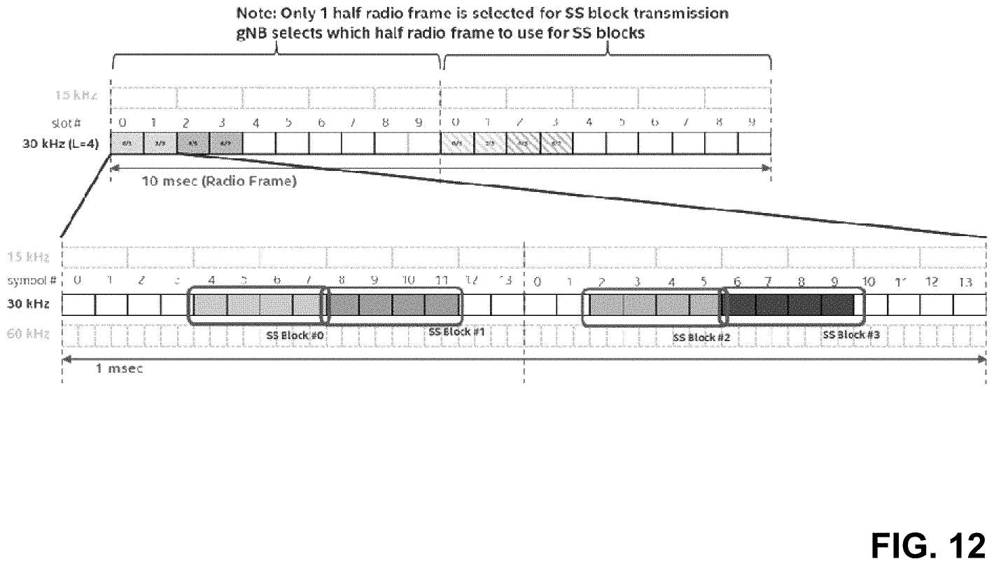

Referring to FIG. 11, illustrated is a diagram showing an example transmission of SSB (Synchronization Signal Block) for up to 8 beams with a subcarrier spacing for SSB of 15 kHz, in connection with various aspects discussed herein. Referring to FIG. 12, illustrated is a diagram showing an example transmission of SSB (Synchronization Signal Block) for up to 8 beams with a subcarrier spacing for SSB of 30 kHz, in connection with various aspects discussed herein. In various embodiments, the slot index and symbol indexes can be fixed for the SSB for each index of the SSB but the fixed position can be different based on the half frame bit which is conveyed via physical broadcast channel (PBCH), which is transmitted with the SSB (e.g., generated by processor(s) 510, transmitted via communication circuitry 520, received via transceiver circuitry 420, and processed by processor(s) 410). If a UE accesses the cell, then the UE first detects (e.g., via processor(s) 410 and transceiver circuitry 420) the SSB for the downlink synchronization and reads the PBCH (which is transmitted close to the SSB) to determine (e.g., via processor(s) 410) the basic information about the cell, including system frame number, SSB information, half frame bit, information for reading, etc. Thus, if the UE receives PBCH successfully (e.g., via transceiver circuitry 420), the UE can determine (e.g., via processor(s) 410) the frame and slot in which the received SSB is actually transmitted.

In general, PRACH is not configured in the slots that are allowed for the transmission of SSBs (e.g., generated by processor(s) 510, transmitted via communication circuitry 520, received via transceiver circuitry 420, and processed by processor(s) 410). However, the number of SSBs and the actual transmission of SSBs can be different, depending on the cell. For example, in some slots that are reserved for transmission of SSBs, there may be no actual transmission of SSB. Therefore, there is still the possibility that some slots configured for SSB can be used for PRACH transmission (e.g., generated by processor(s) 510, transmitted via communication circuitry 520, received via transceiver circuitry 420, and processed by processor(s) 410).

In various embodiments employing the second set of aspects, PRACH configuration can be based on the potential position(s) of SSB blocks.

The PRACH position in the time domain is dependent on the half frame bits included in PBCH (e.g., generated by processor(s) 510, transmitted via communication circuitry 520, received via transceiver circuitry 420, and processed by processor(s) 410). Depending on the half frame bit, all the SSBs can be located in the first half frame inside the 10 ms radio frame or all the SSBs can be located in the second half frame inside the 10 ms radio frame. Therefore, depending on the half frame bit, the PRACH position in the time domain can be differently configured.

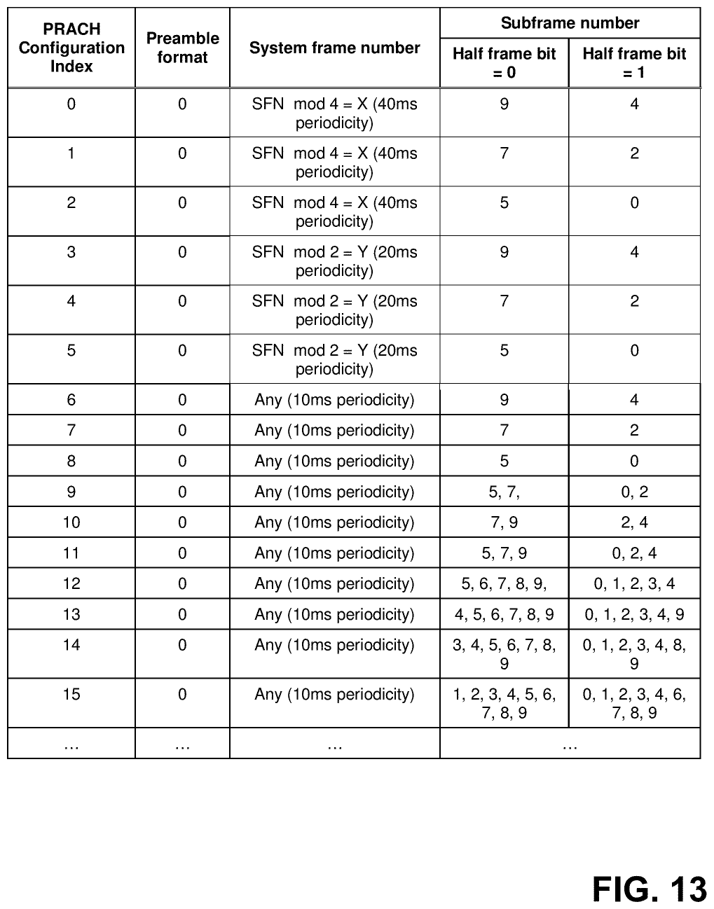

Referring to FIG. 13, illustrated is one example of a PRACH configuration table having different parameters based on the half frame bit, according to various aspects discussed herein. The example shown in FIG. 13 is associated with the scenario wherein PRACH with long sequence is used (e.g., by systems 400 and 500), and 15 kHz subcarrier spacing (SCS) is used (e.g., by systems 400 and 500) for data numerology. In various embodiments, the periodicity of PRACH configuration can be 40 ms, 20 ms, or 10 ms. Additionally, in various embodiments, for the periodicity, X can be either 0, 1, 2, 3 and Y can be either 0 or 1. Depending on the embodiment, X, Y can be fixed in the specification, or can be signaled by PBCH or RMSI (e.g., generated by processor(s) 510, transmitted via communication circuitry 520, received via transceiver circuitry 420, and processed by processor(s) 410).

In some scenarios, there can be no differentiation between the PRACH configurations regardless of half frame bit. For example, for a periodicity larger than 10 ms (20 ms and 40 ms), if the periodicity of SSB is assumed as 20 ms, then there can be a radio frame where there is no slot for SSB transmission. In such scenarios, the slot number can just be defined inside the whole radio frame, without differentiation for the half frame bit.

In various embodiments, the example of FIG. 13 can be extended by having more formats since there can be at least 4 PRACH formats of length 839. Additionally, in various embodiments, the example of FIG. 13 can be extended by having multiple PRACH configurations in the frequency domain (for example, based on whether 1 PRACH occasion is configured or multiple (2, 3, or 4) PRACH occasions are configured for the same slot).

In order to support coexistence between LTE and NR, in various embodiments, the NR PRACH configuration can be aligned with the PRACH configuration used for LTE. For example, if the PRACH configuration table has 256 indexes (e.g., assuming an 8 bit RRC (Radio Resource Control) parameter), 64 indexes out of the 256 indexes for NR PRACH configuration can be reserved for the same configuration with LTE. Alternatively, a subset of LTE configurations, for example, 16 indexes out of 256 can be selected and reserved for utilizing the same configuration with LTE.

In various embodiments employing the second set of embodiments, the PRACH periodicity can be determined differently based on the radio frame in which SSBs are transmitted (e.g., via communication circuitry 420). If the UE receives SSB and corresponding PBCH (e.g., generated by processor(s) 410, transmitted via transceiver circuitry 420, received via communication circuitry 520, and processed by processor(s) 510), the UE can detect (e.g., via processor(s) 410) the subframe number of the detected SSB. Additionally, the UE can assume (e.g., processor(s) 410) that the SSB periodicity is 20 ms and determine in which radio frame the SSBs are transmitted (e.g., via communication circuitry 520). For example, if the detected SSB and PBCH indicates an even number for the system frame number (SFN), then SSB and PBCH can be transmitted (e.g., via communication circuitry 520) in the radio frame of even SFN. Then the NW (Network) can configure (e.g., via higher layer signaling generated by processor(s) 510, transmitted via communication circuitry 520, received via transceiver circuitry 420, and processed by processor(s) 410) the PRACH in the radio frame of odd SFN when the PRACH periodicity is larger than 10 ms.

Thus, in various such aspects, a table of PRACH configurations (e.g., as in FIG. 13) can be defined such that X and Y can be derived (e.g., by processor(s) 410) from the SFN detected from SSB and PBCH (e.g., by processor(s) 410 and transceiver circuitry 420). For example, if the detected SFN is odd, then X can be 0 and Y can be either 0 or 2. As an additional example, if the detected SFN is even, then X can be 1 and Y can be either 1 or 3.

In various embodiments employing the second set of embodiments, based on the PRACH configuration (e.g., as shown in FIG. 13) and actually transmitted SSB indexes, there can be an implicit mapping between SSB and PRACH resources. The number of actually transmitted SSB (e.g., generated by processor(s) 510, transmitted via communication circuitry 520, received via transceiver circuitry 420, and processed by processor(s) 410) can be indicated by RMSI along with the PRACH configuration.

If the number of actually transmitted SSB is configured as A, the number of PRACH slots inside a PRACH periodicity is configured as B, and the number of PRACH occasions multiplexed in frequency domain is configured as C, then the number of PRACH occasions per SSB can be D, where D=B×C/A. In various embodiments, one or more (e.g., all, etc.) of the values A, B, C can be configured by cell-specific RRC (PBCH, RMSI, or SIB) or UE-specific RRC (e.g., generated by processor(s) 510, transmitted via communication circuitry 520, received via transceiver circuitry 420, and processed by processor(s) 410).

If D is an integer number, then one or more PRACH occasions can be defined per SSB using a mapping rule in either a frequency first or a time first manner. In various embodiments, which mapping rule is used can be configured by cell-specific RRC (PBCH, RMSI, or SIB) or UE-specific RRC (e.g., generated by processor(s) 510, transmitted via communication circuitry 520, received via transceiver circuitry 420, and processed by processor(s) 410).

According to an example of a mapping rule of frequency first and time second (e.g., assuming D=1, C=2): (a) a first SSB can be mapped (e.g., by processor(s) 510 and communication circuitry 520) to the first PRACH slot inside a radio frame (or PRACH periodicity) and a first PRACH occasion in the frequency domain; (b) a second SSB can be mapped (e.g., by processor(s) 510 and communication circuitry 520) to the first PRACH slot inside a radio frame (or PRACH periodicity) and a second PRACH occasion in the frequency domain; (c) a third SSB can be mapped (e.g., by processor(s) 510 and communication circuitry 520) to the second PRACH slot inside a radio frame (or PRACH periodicity) and a first PRACH occasion in a frequency domain; etc.

According to an example of a mapping rule of time first and frequency second (assuming D=1, C=2, B=4): (a) a first SSB can be mapped (e.g., by processor(s) 510 and communication circuitry 520) to the first PRACH slot inside a radio frame (or PRACH periodicity) and 1^{st} PRACH occasion in the frequency domain; (b) a second SSB can be mapped (e.g., by processor(s) 510 and communication circuitry 520) to the second PRACH slot inside a radio frame (or PRACH periodicity) and first PRACH occasion in the frequency domain; (c) a third SSB can be mapped (e.g., by processor(s) 510 and communication circuitry 520) to the third PRACH slot inside a radio frame (or PRACH periodicity) and first PRACH occasion in the frequency domain; (d) a fourth SSB can be mapped (e.g., by processor(s) 510 and communication circuitry 520) to the fourth PRACH slot inside a radio frame (or PRACH periodicity) and first PRACH occasion in the frequency domain; (e) a fifth SSB can be mapped (e.g., by processor(s) 510 and communication circuitry 520) to the first PRACH slot inside a radio frame (or PRACH periodicity) and second PRACH occasion in the frequency domain; etc.

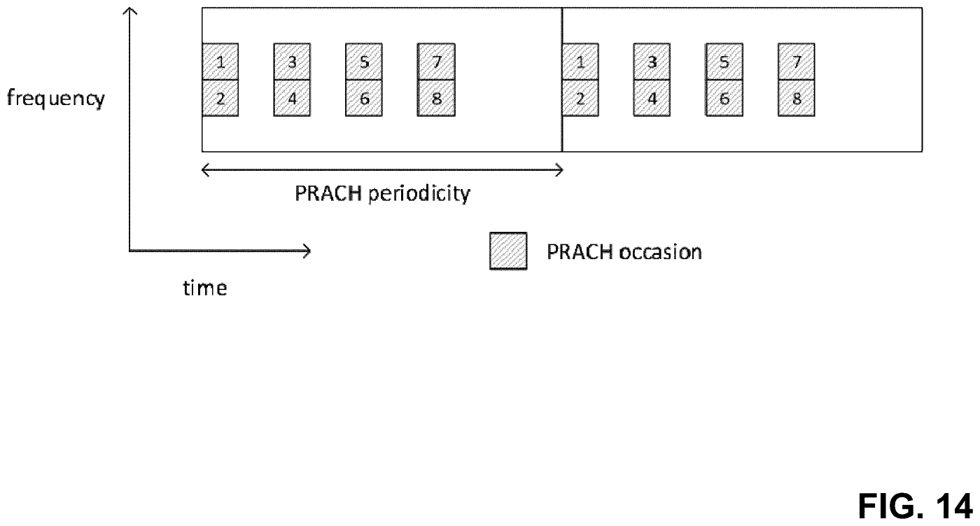

Referring to FIG. 14, illustrated is a diagram showing an example PRACH resource configuration, according to various aspects discussed herein.

The following are additional examples of embodiments that can be employed in connection with the second set of aspects.

In a first such example, the PRACH configuration can be assumed as shown in FIG. 14, and the system can have 4 SSBs (e.g., generated by processor(s) 510, transmitted via communication circuitry 520, received via transceiver circuitry 420, and processed by processor(s) 410) and A=4, B=4, C=2. Then using the equation D=B×C/A, D can be 2.

If frequency first and time second mapping is employed (e.g., by processor(s) 510 and communication circuitry 520), the first SSB can be mapped (e.g., by processor(s) 510 and communication circuitry 520) to PRACH occasions #1 and #2 in FIG. 14, the second SSB can be mapped (e.g., by processor(s) 510 and communication circuitry 520) to PRACH occasions #3 and #4, the third SSB can be mapped (e.g., by processor(s) 510 and communication circuitry 520) to PRACH occasions #5 and #6, and the fourth SSB can be mapped (e.g., by processor(s) 510 and communication circuitry 520) to PRACH occasions #7 and #8 in FIG. 14.

If time first and frequency second mapping is employed (e.g., by processor(s) 510 and communication circuitry 520), a first SSB can be mapped (e.g., by processor(s) 510 and communication circuitry 520) to PRACH occasions #1 and #3 in FIG. 14, a second SSB can be mapped (e.g., by processor(s) 510 and communication circuitry 520) to PRACH occasions #5 and #7, a third SSB can be mapped (e.g., by processor(s) 510 and communication circuitry 520) to PRACH occasions #2 and #4, and a fourth SSB can be mapped (e.g., by processor(s) 510 and communication circuitry 520) to PRACH occasions #6 and #8 in FIG. 14.

If D is less than one, then one RACH occasion can be mapped (e.g., by processor(s) 510 and communication circuitry 520) to multiple SSBs, one set of PRACH preambles can be mapped (e.g., by processor(s) 510 and communication circuitry 520) to one SSB, the next set of PRACH preambles can be mapped (e.g., by processor(s) 510 and communication circuitry 520) to the next SSB, etc. The mapping between PRACH occasions for SSB can be according to various options discussed herein. In various embodiments, one of the following options can be configured by cell-specific RRC (PBCH, RMSI, or SIB) or UE-specific RRC (e.g., generated by processor(s) 510, transmitted via communication circuitry 520, received via transceiver circuitry 420, and processed by processor(s) 410): (1) preamble first, frequency second, time third; (2) preamble first, time second, frequency third; (3) time first, frequency second, preamble third; (4) time first, preamble second, frequency third; (5) frequency first, preamble second, time third; or (6) frequency first, time second, preamble third.

In another example, the PRACH configuration shown in FIG. 14 can be employed, the system can have 16 SSBs, with A=4, B=4, and C=2. Then based on the equation D=BxC/A, D can be 0.5.

If preamble first, frequency second and time third mapping is employed (e.g. by processor(s) 510 and communication circuitry 520), a first SSB can be mapped (e.g. by processor(s) 510 and communication circuitry 520) to the first half preambles of PRACH occasion #1 in FIG. 14, a second SSB can be mapped (e.g. by processor(s) 510 and communication circuitry 520) to the second half preambles of PRACH occasion #1, the third SSB can be mapped (e.g. by processor(s) 510 and communication circuitry 520) to the first half preambles of PRACH occasion #2, the fourth SSB can be mapped (e.g. by processor(s) 510 and communication circuitry 520) to the second half preambles of PRACH occasion #1 in FIG. 14, etc.

In various embodiments, any of the mapping approaches discussed in options above (e.g., with various priorities of frequency, time, and preamble) can be employed, with mapping based on the order associated with that option.

In various embodiments employing the second set of aspects, one or more additional parameters can be defined to differently configure the mapping between SSB and PRACH resources. For example, a certain periodicity can be additionally defined to be used for mapping between SSB and PRACH resources, referred to herein as a SSB mapping periodicity.

If the number of actually transmitted SSB is configured as A, the number of PRACH inside a SSB mapping periodicity in a slot is configured as B₁, and the number of PRACH occasions multiplexed in the frequency domain is configured as C, then the number of PRACH occasions per SSB can be D, where D=B₁×C/A. In various embodiments, one or more of the values A, B₁, or C can be configured by cell-specific RRC (PBCH, RMSI, or SIB) or UE-specific RRC (e.g., generated by processor(s) 510, transmitted via communication circuitry 520, received via transceiver circuitry 420, and processed by processor(s) 410).

In one such example, the PRACH configuration shown in FIG. 14 can be assumed, and the system has 4 SSBs. IF the SSB mapping periodicity is half of the PRACH periodicity then A=4, B₁=2, and C=2. Then based on the equation D=B₁×C/A, D can be 1.

In such a scenario, if frequency first and time second mapping is used (e.g., by processor(s) 410 and communication circuitry 420), the first SSB can be mapped (e.g., by processor(s) 410 and communication circuitry 420) to PRACH occasion #1 in FIG. 14, the second SSB can be mapped (e.g., by processor(s) 410 and communication circuitry 420) to PRACH occasion #2, the third SSB can be mapped (e.g., by processor(s) 410 and communication circuitry 420) to PRACH occasion #3, and the fourth SSB can be mapped (e.g., by processor(s) 410 and communication circuitry 420) to PRACH occasion #4.

In various embodiments employing the second set of aspects, one or more additional parameters can be defined to differently configure the mapping between SSB and PRACH resources. For example, a division number that can be defined that divides the PRACH resources inside the PRACH periodicity.

The number of actually transmitted SSB can be configured as A, the number of PRACH slots in PRACH periodicity can be configured as B₁, the number of PRACH occasions multiplexed in frequency domain can be configured as C, and the division number can be configured as E. Then the number of PRACH occasions per SSB can be D, where D=B₁×C/A/E. Here the all or some of the values A, B, C, E can be configured by cell-specific RRC (PBCH, RMSI, or SIB) or UE-specific RRC (e.g., generated by processor(s) 510, transmitted via communication circuitry 520, received via transceiver circuitry 420, and processed by processor(s) 410).

In one such example, the PRACH configuration shown in FIG. 14 can be assumed, and the system can have 4 SSBs. IF the SSB mapping periodicity is half of the PRACH periodicity, then A=4, B₁=2, C=2. Then D=B₁×C/A, or D=1.

In such scenarios, if frequency first and time second mapping is used (e.g., by processor(s) 510 and communication circuitry 520), a first SSB can be mapped (e.g., by processor(s) 510 and communication circuitry 520) to PRACH occasion #1 in FIG. 14, a second SSB can be mapped (e.g., by processor(s) 510 and communication circuitry 520) to PRACH occasion #2, a third SSB can be mapped (e.g., by processor(s) 510 and communication circuitry 520) to PRACH occasion #3, and a fourth SSB can be mapped (e.g., by processor(s) 510 and communication circuitry 520) to PRACH occasion #4.

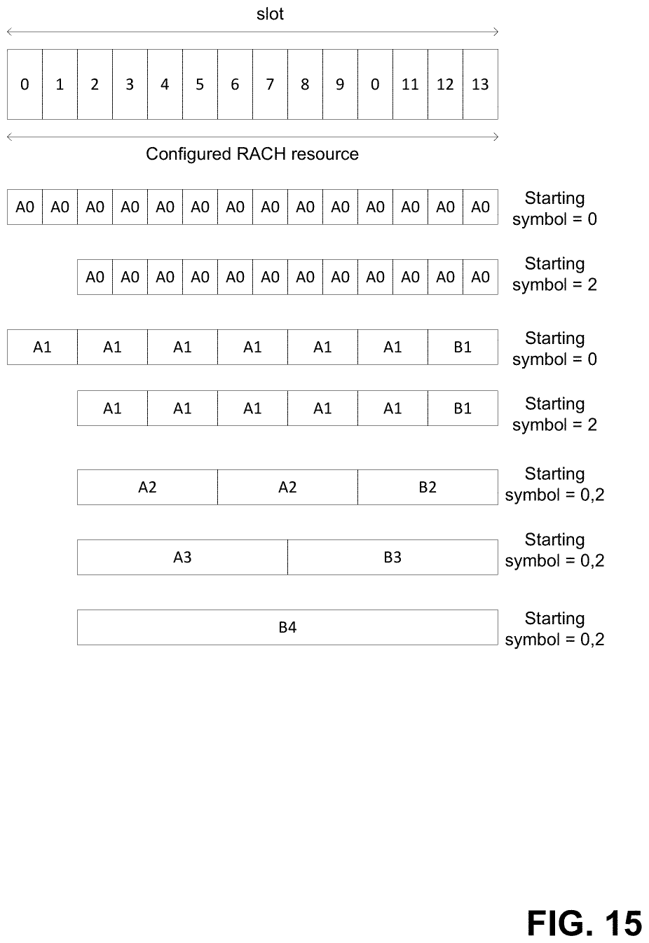

In various embodiments employing the second set of aspects, if the short sequence is used for PRACH, the starting symbols can be either 0 or 2 symbols. Thus, different scenarios can be defined. However, depending on the PRACH format, there is no difference between the starting symbols. For example, PRACH formats A2, A3, B2, B3, and B4 use the repetition of 4, 6, or 12. Thus for these formats, it does not matter whether the starting symbol is 0 or 2. Thus, in various embodiments, different PRACH configurations (e.g., with starting symbols of 0 or 2) can be used for PRACH formats A0, A1 and B1, but for PRACH formats A2, A3, B2, B3, and B4, the fixed 12 symbols out of 14 symbols inside a slot can be used. Referring to FIG. 15, illustrated is a diagram showing different configurations for a short PRACH sequence including common configurations for formats A2, A3, and B4 regardless of starting symbol, according to various aspects discussed herein.

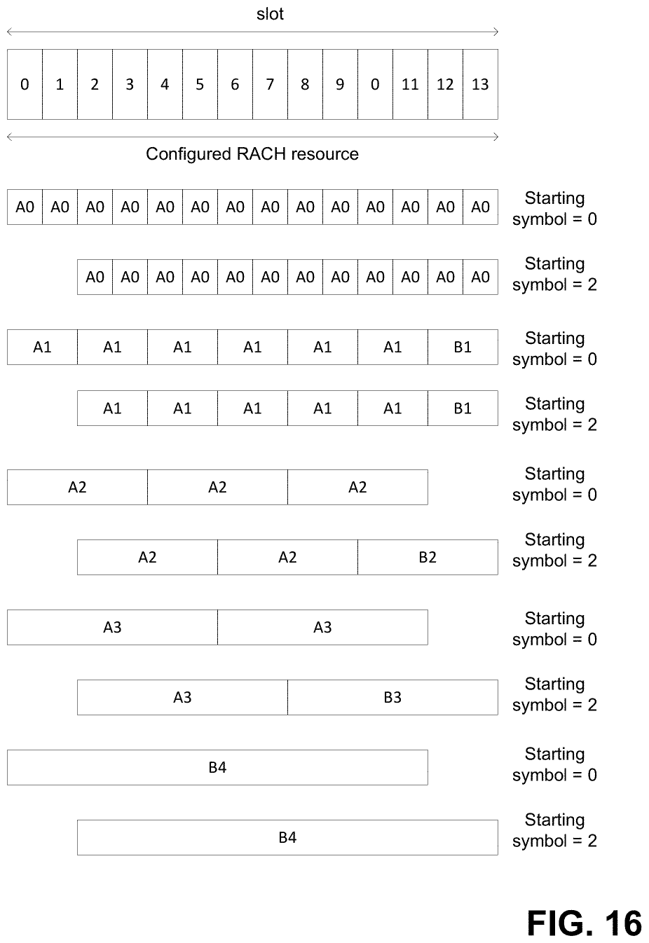

Referring to FIG. 16, illustrated is a diagram showing different configurations for a short PRACH sequence including different configurations for formats A2, A3, and B4 depending on starting symbol, according to various aspects discussed herein. As shown in FIG. 16, for formats A2, A3, depending on the starting symbols, the last PRACH can be either A2/A3 or B2/B3.

In various embodiments employing the second set of aspects, if the short sequence is used, there can be 4 possible subcarrier spacings for one PRACH format. In various embodiments, instead of defining a different PRACH configuration table for each subcarrier spacing, the same table (e.g., FIG. 13) can be employed for each possible subcarrier spacing, but interpreted differently.

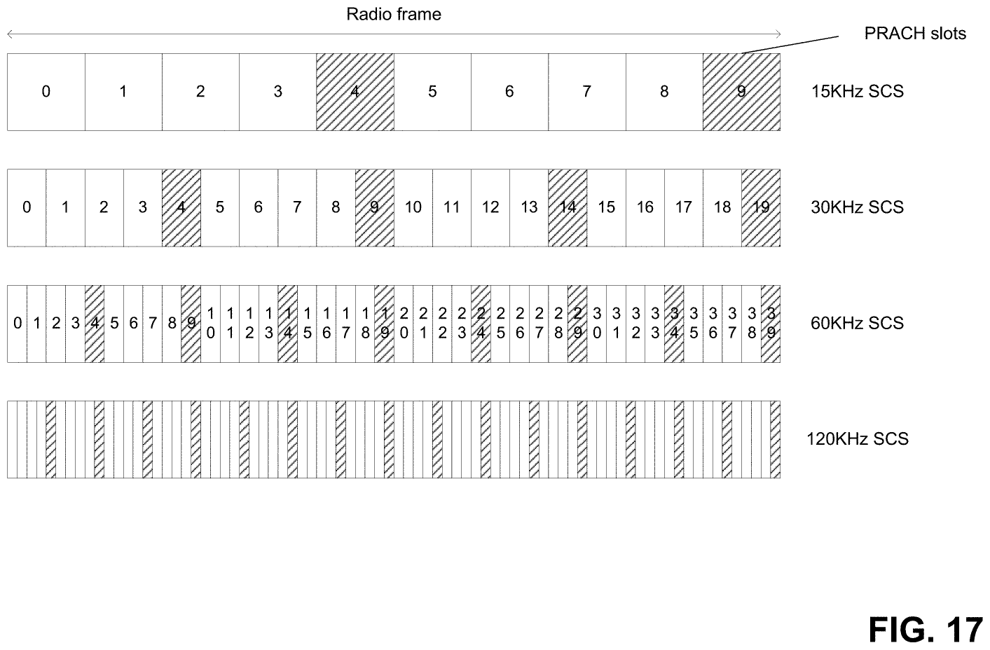

Referring to FIG. 17, illustrated is a diagram showing an example of a first option for applying PRACH configurations for different subcarrier spacings, according to various aspects discussed herein. In the example of FIG. 17, if slot 4 and 9 are configured for PRACH, slot p can be used for PRACH occasions, where p mod 10=4 or 9 regardless of the subcarrier spacing, as shown in FIG. 17.

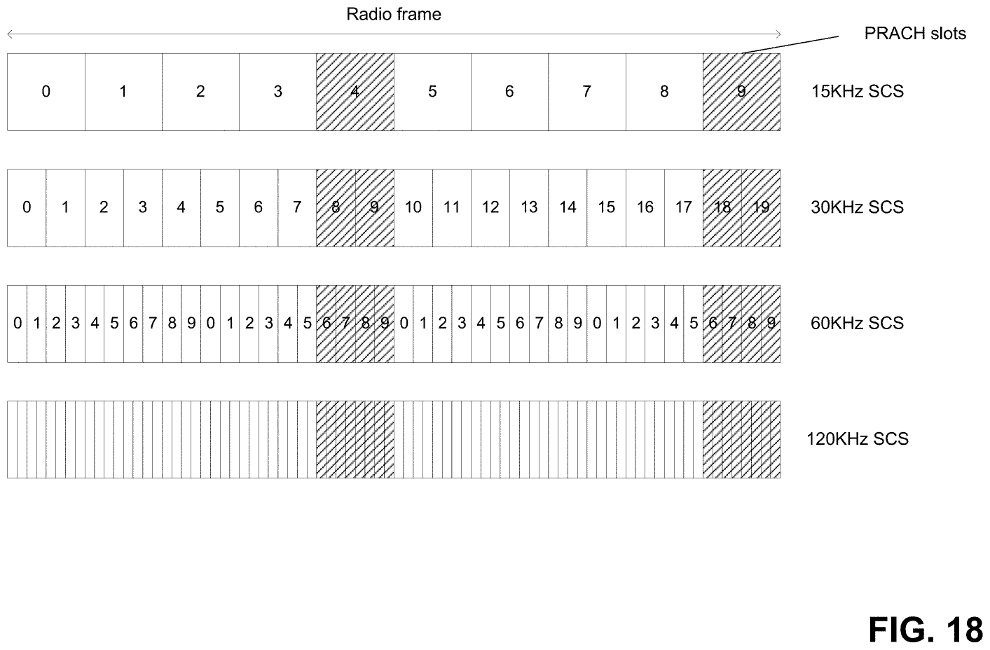

Referring to FIG. 18, illustrated is a diagram showing an example of a second option for applying PRACH configurations for different subcarrier spacings, according to various aspects discussed herein. In the example of FIG. 18, if slot 4 and 9 is configured for PRACH, slots 4 and 9 (assuming 15 kHz SCS) are used for PRACH occasion and the same relevant resources will be used for PRACH for 30/60/120 kHz SCS, as shown in FIG. 18. This can be interpreted as subframe 4 and subframe 9 being configured as PRACH occasion regardless of SCS.

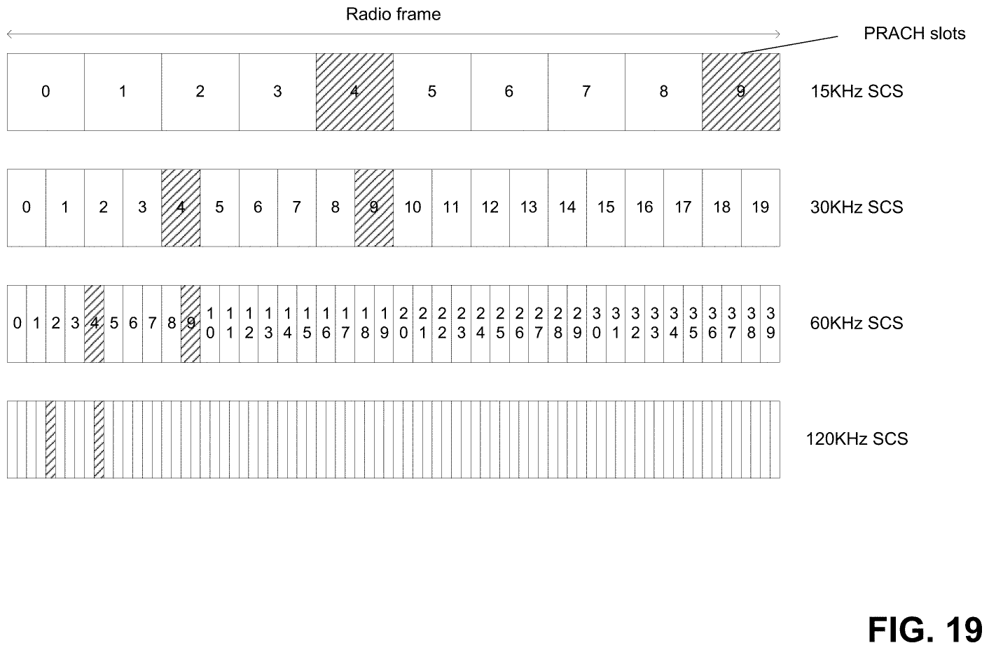

Referring to FIG. 19, illustrated is a diagram showing an example of a third option for applying PRACH configurations for different subcarrier spacings, according to various aspects discussed herein. In the example of FIG. 19, if slot 4 and 9 is configured for PRACH, only slot 4 and slot 9 are used, regardless of SCS, as shown in FIG. 19.

In various embodiments employing the second set of aspects, PRACH can be overlapped with reserved resource. The reserved resource can be configured by higher layer signaling (e.g., generated by processor(s) 510, transmitted via communication circuitry 520, received via transceiver circuitry 420, and processed by processor(s) 410) in a UE-specific manner, but the PRACH resource can be configured by RMSI (e.g., generated by processor(s) 510, transmitted via communication circuitry 520, received via transceiver circuitry 420, and processed by processor(s) 410). Thus, a UE does not know whether the PRACH resource is overlapped with reserved resource or not when the UE performs the PRACH transmission (e.g., via processor(s) 410 and transceiver circuitry 420) for the purpose of initial access to a cell. In such scenarios, if the reserved resource overlaps with PRACH occasions, the reserved resources are not actually guaranteed to be ‘reserved’.

Even after the UE-specific configuration, the PRACH signal can use a 1.25 KHz subcarrier spacing for some PRACH formats, so the symbol length can be much larger than normal data (e.g., 15 kHz). If a certain number of OFDM symbols is declared as ‘reserved’ inside the PRACH slot, it can be difficult to puncture out only the reserved part.

Thus, in various embodiments, if the PRACH occasion chosen for the PRACH transmission by MAC (e.g., generated by processor(s) 510, transmitted via communication circuitry 520, received via transceiver circuitry 420, and processed by processor(s) 410) overlaps with resources declared as ‘reserved’, the UE can transmit (e.g., via transceiver circuitry 420) PRACH (e.g., generated by processor(s) 410) on that PRACH occasion without any puncturing.

Alternatively, in various embodiments employing the second set of aspects, if the PRACH occasion chosen for the PRACH transmission by MAC overlaps with resources declared as ‘reserved’, the UE can (a) transmit (e.g., via transceiver circuitry 420) PRACH (e.g., generated by processor(s) 410) on that PRACH occasion without any puncturing when reserved resources are not configured for the UE (e.g., for initial access) and (b) skip the PRACH transmission when reserved resource is configured for the UE.

Alternatively, in various embodiments employing the second set of aspects, if the PRACH occasion chosen for the PRACH transmission by MAC overlaps with resources declared as ‘reserved’, the UE can (a) transmit (e.g., via transceiver circuitry 420) PRACH (e.g., generated by processor(s) 410) on that PRACH occasion without any puncturing when reserved resources are not configured for the UE (e.g., for initial access) and (b) select (e.g., via processor(s) 410) another PRACH occasion that does not overlap with reserved resource when reserved resources are configured for the UE.

### Additional Embodiments

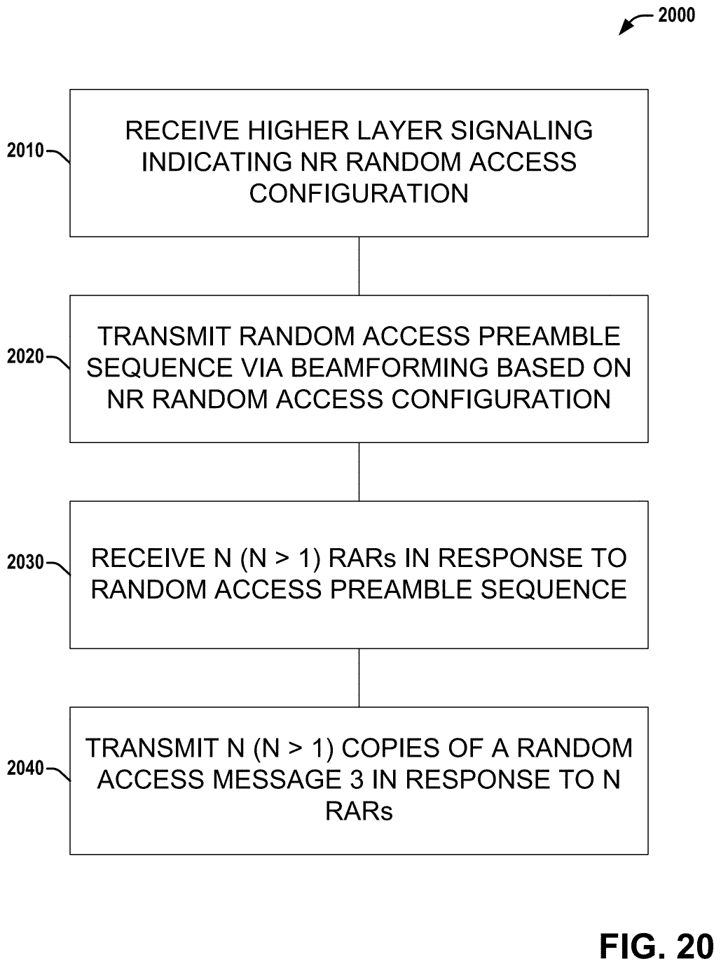

Referring to FIG. 20, illustrated is a flow diagram of an example method 2000 employable at a UE that facilitates multi-beam operation of a NR (New Radio) PRACH (Physical Random Access Channel), according to various aspects discussed herein. In other aspects, a machine readable medium can store instructions associated with method 2000 that, when executed, can cause a UE to perform the acts of method 2000.

At 2010, higher layer signaling can be received that indicates a NR random access configuration.

At 2020, a random access preamble sequence can be transmitted via beamforming based on the NR random access configuration via one or more beams.

At 2030, N (e.g., with N>1) RARs can be received in response to the random access preamble sequence.

At 2040, N (e.g., with N>1) copies of a random access Msg3 can be transmitted in response to the plurality (e.g., N) of RARs.

Additionally or alternatively, method 2000 can include one or more other acts described herein in connection with various embodiments of system 400 discussed herein in connection with the first set of aspects.

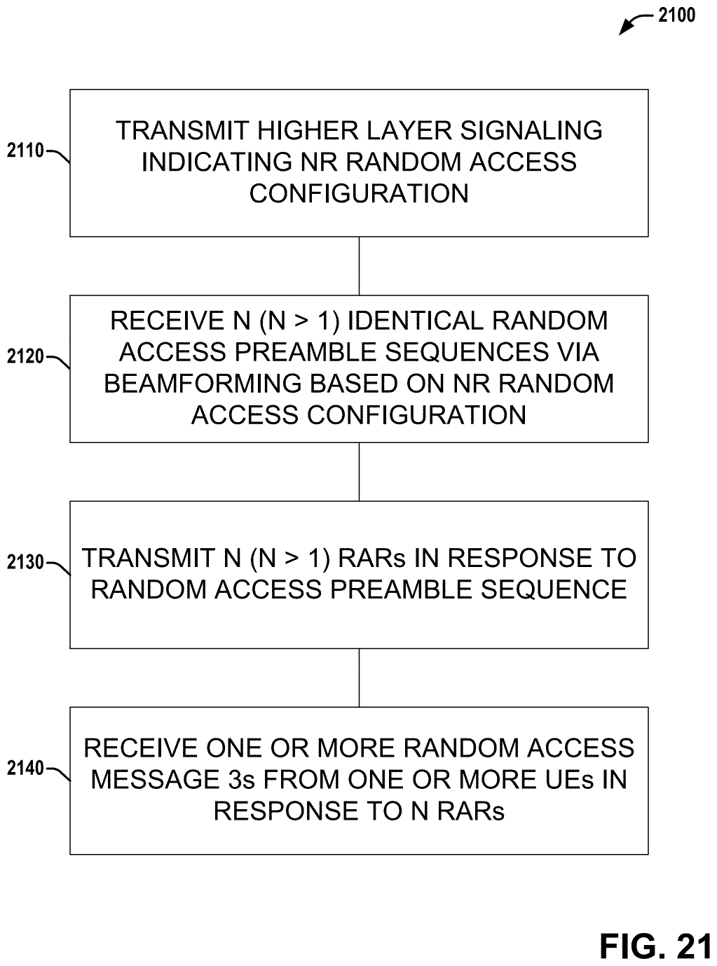

Referring to FIG. 21, illustrated is a flow diagram of an example method 2100 employable at a BS that facilitates multi-beam operation of a NR (New Radio) PRACH (Physical Random Access Channel), according to various aspects discussed herein. In other aspects, a machine readable medium can store instructions associated with method 2100 that, when executed, can cause a BS (e.g., eNB, gNB, etc.) to perform the acts of method 2100.

At 2110, higher layer signaling can be transmitted that indicates a NR random access configuration.

At 2120, N (e.g., with N>1) identical random access preambles can be received from one or more UEs.

At 2130, N (e.g., with N>1) RARs can be transmitted in response to the N identical random access preambles.

At 2140, one or more Msg3s can be received from one or more UEs in response to the N (e.g., with N>1) RARs.

Additionally or alternatively, method 2100 can include one or more other acts described herein in connection with various embodiments of system 500 discussed herein in connection with the first set of aspects.

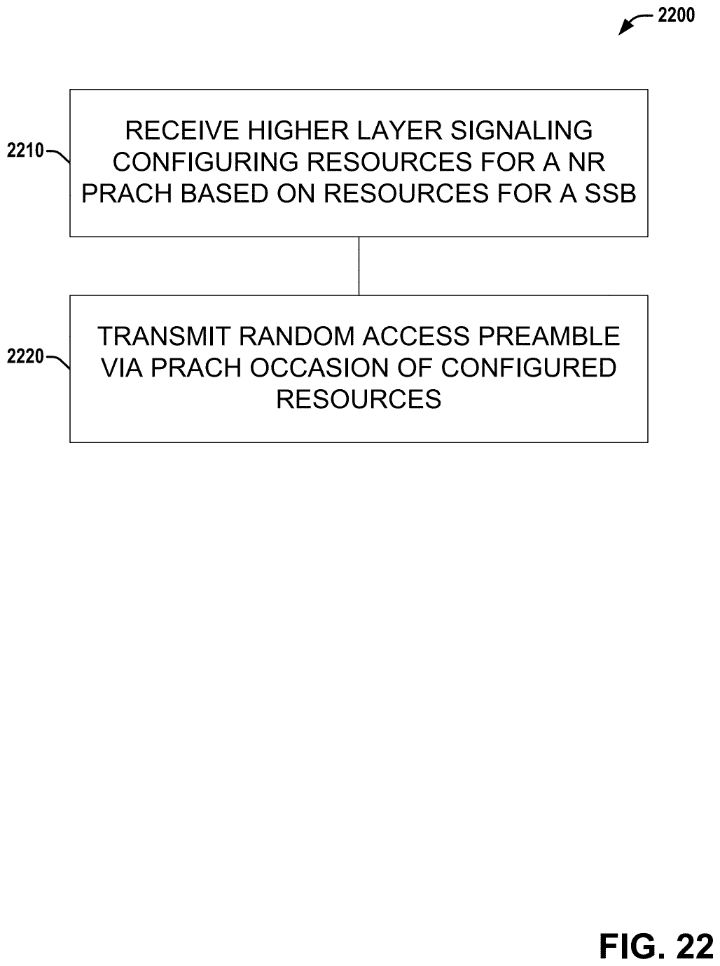

Referring to FIG. 22, illustrated is a flow diagram of an example method 2200 employable at a UE that facilitates configuration of a NR (New Radio) PRACH (Physical Random Access Channel), according to various aspects discussed herein. In other aspects, a machine readable medium can store instructions associated with method 2000 that, when executed, can cause a UE to perform the acts of method 2200.

At 2210, higher layer signaling can be received configuring resources for a NR PRACH based on resources for a SSB.

At 2320, a random access preamble can be transmitted via a PRACH occasion of the resources configured for the NR PRACH.

Additionally or alternatively, method 2200 can include one or more other acts described herein in connection with various embodiments of system 400 discussed herein in connection with the second set of aspects.

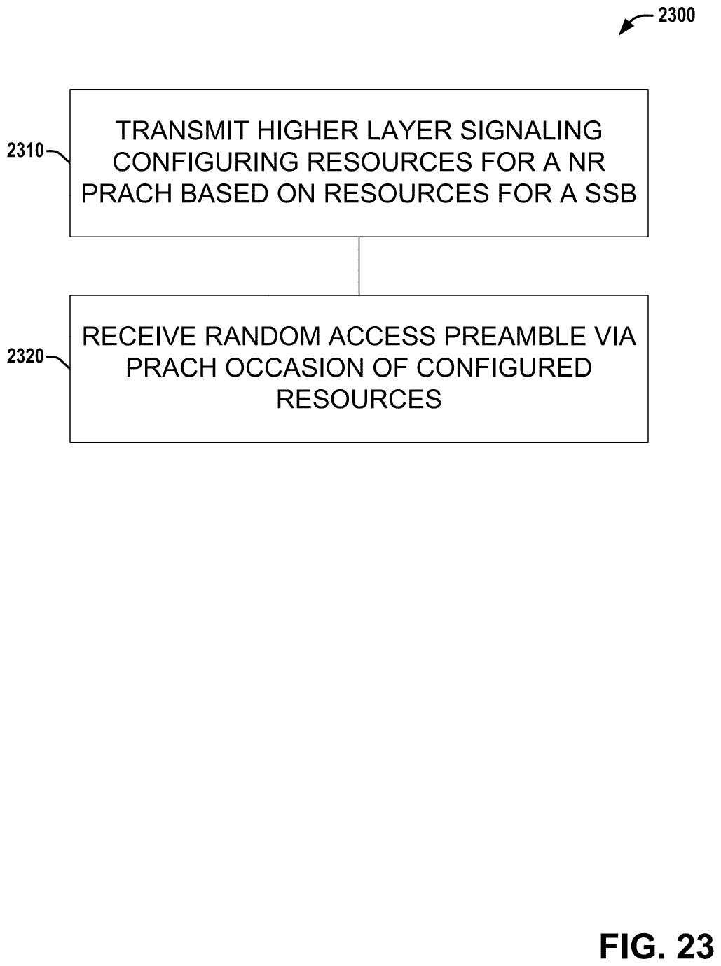

Referring to FIG. 23, illustrated is a flow diagram of an example method 2300 employable at a BS that facilitates configuration of a NR (New Radio) PRACH (Physical Random Access Channel), according to various aspects discussed herein. In other aspects, a machine readable medium can store instructions associated with method 2300 that, when executed, can cause a BS (e.g., eNB, gNB, etc.) to perform the acts of method 2300.

At 2310, higher layer signaling can be transmitted configuring resources for a NR PRACH based on resources for a SSB.

At 2320, a random access preamble can be received via a PRACH occasion of the resources configured for the NR PRACH.

Additionally or alternatively, method 2300 can include one or more other acts described herein in connection with various embodiments of system 500 discussed herein in connection with the second set of aspects.

A first example embodiment employable in connection with the first set of aspects discussed herein can comprise a system and/or method of wireless communication for a fifth generation (5G) or new radio (NR) system, comprising: transmitting (e.g., via communication circuitry 520), by a BS (e.g., NR NodeB (gNB)), a random access configuration (e.g., generated by processor(s) 510); Receiving (e.g., via communication circuitry 520), by the BS (e.g., gNB), the same random access preamble sequence (e.g., two or more copies from one or more UEs, generated by respective processor(s) 410 and transmitted by respective transceiver circuitries 420); Transmitting (e.g., via communication circuitry 520) multiple random access responses for the same random access preamble sequence; and transmitting (e.g., via respective transceiver circuitries 420) message 3 (e.g., generated by respective processor(s) 410) multiple times depending on the number of received random access responses (e.g., generated by processor(s) 510, transmitted via communication circuitry 520, received via transceiver circuitry 420, and processed by processor(s) 410).

In various aspects of the first example embodiment employable in connection with the first set of aspects, multiple random access responses can be multiplexed (e.g., by processor(s) 510 and communication circuitry 520) in one random access response MAC PDU (e.g., generated by processor(s) 510).

A second example embodiment employable in connection with the first set of aspects discussed herein can comprise a system and/or method of wireless communication for a fifth generation (5G) or new radio (NR) system, comprising: transmitting (e.g., via communication circuitry 520), by a BS (e.g., NR NodeB (gNB)), a random access configuration (e.g., generated by processor(s) 510); and transmitting (e.g., via communication circuitry 520), by a BS (e.g., NR NodeB (gNB)), the configuration of random access resources (e.g., generated by processor(s) 510) to support multiple beam operation.

In various aspects of the second example embodiment employable in connection with the first set of aspects, configuration of random access resource can comprise the mapping between synchronization signal and random access resources, and the mapping can be done for one or more of a time domain, a frequency domain, or a code domain. In various such aspects, there can be priorities among the time domain, the frequency domain, and the code domain.

In various aspects of the second example embodiment employable in connection with the first set of aspects, the configuration of random access resources can be transmitted using a control channel which is masked with an ID, wherein the ID can be generated by a linear combination of a code index, a time index, and a frequency index.

A third example embodiment employable in connection with the first set of aspects discussed herein can comprise a system and/or method of wireless communication for a fifth generation (5G) or new radio (NR) system, comprising: transmitting (e.g., via communication circuitry 520), by a BS (e.g., NR NodeB (gNB)), a random access configuration (e.g., generated by processor(s) 510); and transmitting (e.g., via transceiver circuitry 420), by a UE, a random access message-3 (e.g., generated by processor(s) 410) comprising information indicating the best gNB Tx beam information.

In various aspects of the third example embodiment employable in connection with the first set of aspects, the best gNB Tx beam information can be included in the MAC CE of the random access message-3.

A first example embodiment employable in connection with the second set of aspects discussed herein can comprise a system and/or method of wireless communication for a fifth generation (5G) or new radio (NR) system, comprising: transmitting (e.g., via transceiver circuitry 420) by a UE a physical random access channel (PRACH) (e.g., via transceiver circuitry 420) in a configured PRACH resource; and configuring by a NW (e.g., via configuration signaling generated by processor(s) 510, transmitted via communication circuitry 520, received via transceiver circuitry 420, and processed by processor(s) 410) the PRACH resource for a cell.

In various aspects of the first example embodiment employable in connection with the second set of aspects, the PRACH configuration depends on SSB position of a slot

In various aspects of the first example embodiment employable in connection with the second set of aspects, the mapping between SSB and PRACH is determined based on the PRACH configuration and the SSB configuration. In various such aspects, the mapping rule is based on one or more of a preamble domain, a frequency domain, and a time domain ordered based on associated priorities.

In various aspects of the first example embodiment employable in connection with the second set of aspects, only a part of the PRACH formats depends on the starting symbols of the PRACH occasions.

In various aspects of the first example embodiment employable in connection with the second set of aspects, a slot index of the PRACH occasion is determined by the modular arithmetic

In various aspects of the first example embodiment employable in connection with the second set of aspects, if the PRACH occasion is overlapped with reserved resource, the PRACH is transmitted with a higher priority than the reserved resource.

Example 1 is an apparatus configured to be employed in a UE (User Equipment), comprising: a memory interface; and processing circuitry configured to: process higher layer signaling indicating a NR (New Radio) random access configuration; generate a random access preamble sequence based at least in part on the random access configuration; map the random access preamble sequence to a set of resources for each of a plurality of sets of beamforming weights; process N RARs (Random Access Responses) associated with the random access preamble sequence, wherein N is an integer greater than one; generate a random access Msg3 (message 3); map N copies of the random access Msg3 to a PUSCH (Physical Uplink Shared Channel); and send the NR random access configuration to a memory via the memory interface.

Example 2 comprises the subject matter of any variation of any of example(s) 1, wherein a single MAC (Medium Access Control) PDU (Protocol Data Unit) comprises the N RARs.

Example 3 comprises the subject matter of any variation of any of example(s) 1-2, wherein the NR random access configuration comprises an indication of resources associated with multi-beam random access operation, wherein the resources associated with multi-beam operation comprise the set of resources for each of the plurality of sets of beamforming weights.

Example 4 comprises the subject matter of any variation of any of example(s) 3, wherein the NR random access configuration indicates a mapping between SS (Synchronization Signal) resources and the resources associated with multi-beam random access operation, wherein the mapping is indicated for one or more of a time domain, a frequency domain, or a code domain.

Example 5 comprises the subject matter of any variation of any of example(s) 4, wherein the mapping the is indicated for two or more of the time domain, the frequency domain, or the code domain, and wherein the NR random access configuration indicates an associated priority for each of the two or more of the time domain, the frequency domain, or the code domain.

Example 6 comprises the subject matter of any variation of any of example(s) 3, wherein the indication of the resources associated with multi-beam random access operation is masked with an ID (Identifier), wherein the ID is generated based on a linear combination of one or more of a code index, a time index, or a frequency index.

Example 7 comprises the subject matter of any variation of any of example(s) 1-2, wherein the random access Msg3 comprises an indication of a best gNB (next generation Node B) Tx (Transmit) beam.

Example 8 comprises the subject matter of any variation of any of example(s) 7, wherein the random access Msg3 comprises a MAC (Medium Access Control) CE (Control Element) that comprises the indication of the best gNB Tx beam.

Example 9 comprises the subject matter of any variation of any of example(s) 1-2, wherein the higher layer signaling comprises a SIB (System Information Block).

Example 10 is an apparatus configured to be employed in a gNB (next generation Node B), comprising: a memory interface; and processing circuitry configured to: generate higher layer signaling indicating a NR (New Radio) random access configuration; process N identical random access preamble sequences, wherein the random access preamble sequences are based at least in part on the random access configuration, wherein N is an integer greater than one; generate N RARs (Random Access Responses) associated with the N identical random access preamble sequences; process one or more random access Msg3s (Message 3s) associated with one or more UEs (User Equipments), wherein the one or more random access Msg3s are based at least in part on the N RARs; and send the NR random access configuration to a memory via the memory interface.

Example 11 comprises the subject matter of any variation of any of example(s) 10, wherein the processing circuitry is further configured to generated a MAC (Medium Access Control) PDU (Protocol Data Unit) comprising the N RARs associated with the N identical random access preamble sequences.

Example 12 comprises the subject matter of any variation of any of example(s) 10-11, wherein the NR random access configuration comprises an indication of resources associated with multi-beam random access operation.

Example 13 comprises the subject matter of any variation of any of example(s) 11, wherein the indication of the resources associated with multi-beam random access operation comprises a mapping between SS (Synchronization Signal) resources and the resources associated with multi-beam random access operation, and wherein the mapping is based on at least one of a code domain, a frequency domain, or a time domain.

Example 14 comprises the subject matter of any variation of any of example(s) 13, wherein the indication of the resources associated with multi-beam random access operation comprises an associated priority for each of the at least one of the code domain, the frequency domain, or the time domain.

Example 15 comprises the subject matter of any variation of any of example(s) 12, wherein the processing circuitry is further configured to mask the indication of the resources associated with multi-beam random access operation based on an ID (Identifier) generated based on a linear combination of at least one of a code index, a frequency index, or a time index.

Example 16 comprises the subject matter of any variation of any of example(s) 10-11, wherein each of the one or more random access Msg3s comprises an associated indication of a best gNB Tx beam.

Example 17 comprises the subject matter of any variation of any of example(s) 16, wherein each of the one or more random access Msg3s comprises a MAC (Medium Access Control) CE (Control Element) that comprises the associated indication of the best gNB Tx beam.

Example 18 comprises the subject matter of any variation of any of example(s) 17, wherein the processing circuitry is configured to generate, for each random access Msg3 of the one or more random access Msg3s, an associated random access Msg4 (Message 4) based at least in part on the associated indication of the best gNB Tx beam of that random access Msg3.

Example 19 is an apparatus configured to be employed in a UE (User Equipment), comprising: a memory interface; and processing circuitry configured to: process higher layer signaling indicating a configuration for a NR (New Radio) PRACH (Physical Random Access Channel) comprising an indication of a first set of resources for the NR PRACH, wherein the configuration for the NR PRACH is based at least in part on a configuration for a SSB (Synchronization Signal Block) comprising an indication of a second set of resources associated with the SSB; generate a random access preamble; map the random access preamble to a PRACH occasion of the first set of resources; and send an indication of the first set of resources to a memory via the memory interface.

Example 20 comprises the subject matter of any variation of any of example(s) 19, wherein the higher layer signaling comprises a SIB (System Information Block).

Example 21 comprises the subject matter of any variation of any of example(s) 19, wherein the processing circuitry is further configured to determine a mapping between the SSB and the NR PRACH based at least in part on the configuration for the NR PRACH and the configuration for the SSB.

Example 22 comprises the subject matter of any variation of any of example(s) 21, wherein the mapping is based on one or more of a preamble domain, a frequency domain, or a time domain, and wherein an order of the mapping is based on associated priorities for the one or more of the preamble domain, the frequency domain, or the time domain.

Example 23 comprises the subject matter of any variation of any of example(s) 22, wherein, for a plurality of PRACH occasions comprising the PRACH occasion, the order of the mapping is: mapping first in the preamble domain in increasing order of preamble indexes within each PRACH occasion of the plurality of PRACH occasions, mapping second in the frequency domain in increasing order of frequency resource indexes for one or more frequency multiplexed PRACH occasions of the plurality of PRACH occasions, mapping third in the time domain in increasing order of time resource indexes for one or more time multiplexed PRACH occasions of the plurality of PRACH occasions, and mapping fourth in increasing order of indexes for PRACH slots comprising one or more PRACH occasions of the plurality of PRACH occasions.

Example 24 comprises the subject matter of any variation of any of example(s) 19-23, wherein a PRACH format of the random access preamble is based at least in part on a starting symbol of the PRACH occasion of the first set of resources.

Example 25 comprises the subject matter of any variation of any of example(s) 19-23, wherein a PRACH format of the random access preamble is independent of a starting symbol of a PRACH occasion of the first set of resources.

Example 26 comprises the subject matter of any variation of any of example(s) 25, wherein the PRACH format is one of A2, A3, B2, B3, or B4.

Example 27 comprises the subject matter of any variation of any of example(s) 25, wherein the configuration for the NR PRACH configures both an A format PRACH and a B format PRACH, and wherein the processing circuitry is configured to: generate the random access preamble based on the B format PRACH when the PRACH occasion is a last PRACH occasion of a slot; and generate the random access preamble based on the A format PRACH when the PRACH occasion is not the last PRACH occasion of the slot.

Example 28 comprises the subject matter of any variation of any of example(s) 19-23, wherein the processing circuitry is further configured to determine a slot index for the PRACH occasion of the first set of resources based on applying modular arithmetic in connection with the indication of the first set of resources.

Example 29 comprises the subject matter of any variation of any of example(s) 19-23, wherein the PRACH occasion overlaps with reserved resources, and wherein the PRACH occasion has a higher priority than the reserved resources.

Example 30 is an apparatus configured to be employed in a gNB (next generation Node B), comprising: a memory interface; and processing circuitry configured to: generate higher layer signaling indicating a first set of resources for a NR (New Radio) PRACH (Physical Random Access Channel), wherein the configuration for the NR PRACH is based at least in part on a second set of resources associated with a SSB (Synchronization Signal Block); process a random access preamble from a PRACH occasion of the first set of resources; and send the random access preamble to a memory via the memory interface.

Example 31 comprises the subject matter of any variation of any of example(s) 30, wherein the first set of resources are based on a mapping from the second set of resources according to a mapping rule.

Example 32 comprises the subject matter of any variation of any of example(s) 31, wherein the mapping rule is based on one or more of a preamble domain, a frequency domain, or a time domain, wherein the order of the mapping of the one or more of the preamble domain, the frequency domain, or the time domain is based on associated priorities of the one or more of the preamble domain, the frequency domain, or the time domain.

Example 33 comprises the subject matter of any variation of any of example(s) 32, wherein, for a plurality of PRACH occasions comprising the PRACH occasion, the order of the mapping is: mapping first in the preamble domain in increasing order of preamble indexes within each PRACH occasion of the plurality of PRACH occasions, mapping second in the frequency domain in increasing order of frequency resource indexes for one or more frequency multiplexed PRACH occasions of the plurality of PRACH occasions, mapping third in the time domain in increasing order of time resource indexes for one or more time multiplexed PRACH occasions of the plurality of PRACH occasions, and mapping fourth in increasing order of indexes for PRACH slots comprising one or more PRACH occasions of the plurality of PRACH occasions.

Example 34 comprises the subject matter of any variation of any of example(s) 30-33, processing circuitry is further configured to determine a slot index for the PRACH occasion of the first set of resources based on applying modular arithmetic in connection with the indication of the first set of resources.

Example 35 comprises the subject matter of any variation of any of example(s) 30-33, wherein a PRACH format of the random access preamble is independent of a starting symbol of a PRACH occasion of the first set of resources.

Example 36 comprises an apparatus comprising means for executing any of the described operations of examples 1-35.

Example 37 comprises a machine readable medium that stores instructions for execution by a processor to perform any of the described operations of examples 1-35.

Example 38 comprises an apparatus comprising: a memory interface; and processing circuitry configured to: perform any of the described operations of examples 1-35.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

1-35. (canceled)

36. An apparatus configured to be employed in a UE (User Equipment), comprising:
a memory interface; and
processing circuitry configured to:
process higher layer signaling indicating a NR (New Radio) random access configuration;
generate a random access preamble sequence based at least in part on the random access configuration;
map the random access preamble sequence to a set of resources for each of a plurality of sets of beamforming weights;
process N RARs (Random Access Responses) associated with the random access preamble sequence, wherein N is an integer greater than one;
generate a random access Msg3 (message 3);
map N copies of the random access Msg3 to a PUSCH (Physical Uplink Shared Channel); and
send the NR random access configuration to a memory via the memory interface.

37. The apparatus of claim 36, wherein a single MAC (Medium Access Control) PDU (Protocol Data Unit) comprises the N RARs.

38. The apparatus of claim 36, wherein the NR random access configuration comprises an indication of resources associated with multi-beam random access operation, wherein the resources associated with multi-beam operation comprise the set of resources for each of the plurality of sets of beamforming weights.

39. The apparatus of claim 38, wherein the NR random access configuration indicates a mapping between SS (Synchronization Signal) resources and the resources associated with multi-beam random access operation, wherein the mapping is indicated for one or more of a time domain, a frequency domain, or a code domain.

40. The apparatus of claim 39, wherein the mapping the is indicated for two or more of the time domain, the frequency domain, or the code domain, and wherein the NR random access configuration indicates an associated priority for each of the two or more of the time domain, the frequency domain, or the code domain.

41. The apparatus of claim 38, wherein the indication of the resources associated with multi-beam random access operation is masked with an ID (Identifier), wherein the ID is generated based on a linear combination of one or more of a code index, a time index, or a frequency index.

42. The apparatus of claim 36, wherein the random access Msg3 comprises an indication of a best gNB (next generation Node B) Tx (Transmit) beam.

43. The apparatus of claim 42, wherein the random access Msg3 comprises a MAC (Medium Access Control) CE (Control Element) that comprises the indication of the best gNB Tx beam.

44. The apparatus of claim 36, wherein the higher layer signaling comprises a SIB (System Information Block).

45. An apparatus configured to be employed in a gNB (next generation Node B), comprising:
a memory interface; and
processing circuitry configured to:
generate higher layer signaling indicating a NR (New Radio) random access configuration;
process N identical random access preamble sequences, wherein the random access preamble sequences are based at least in part on the random access configuration, wherein N is an integer greater than one;
generate N RARs (Random Access Responses) associated with the N identical random access preamble sequences;
process one or more random access Msg3s (Message 3s) associated with one or more UEs (User Equipments), wherein the one or more random access Msg3s are based at least in part on the N RARs; and
send the NR random access configuration to a memory via the memory interface.

46. The apparatus of claim 45, wherein the processing circuitry is further configured to generated a MAC (Medium Access Control) PDU (Protocol Data Unit) comprising the N RARs associated with the N identical random access preamble sequences.

47. The apparatus of claim 46, wherein the NR random access configuration comprises an indication of resources associated with multi-beam random access operation.

48. The apparatus of claim 46, wherein the indication of the resources associated with multi-beam random access operation comprises a mapping between SS (Synchronization Signal) resources and the resources associated with multi-beam random access operation, and wherein the mapping is based on at least one of a code domain, a frequency domain, or a time domain.

49. The apparatus of claim 48, wherein the indication of the resources associated with multi-beam random access operation comprises an associated priority for each of the at least one of the code domain, the frequency domain, or the time domain.

50. The apparatus of claim 47, wherein the processing circuitry is further configured to mask the indication of the resources associated with multi-beam random access operation based on an ID (Identifier) generated based on a linear combination of at least one of a code index, a frequency index, or a time index.

51. The apparatus of claim 45, wherein each of the one or more random access Msg3s comprises an associated indication of a best gNB Tx beam.

52. The apparatus of claim 51, wherein each of the one or more random access Msg3s comprises a MAC (Medium Access Control) CE (Control Element) that comprises the associated indication of the best gNB Tx beam.

53. The apparatus of claim 52, wherein the processing circuitry is configured to generate, for each random access Msg3 of the one or more random access Msg3s, an associated random access Msg4 (Message 4) based at least in part on the associated indication of the best gNB Tx beam of that random access Msg3.

54. An apparatus configured to be employed in a UE (User Equipment), comprising:
a memory interface; and
processing circuitry configured to:
process higher layer signaling indicating a configuration for a NR (New Radio) PRACH (Physical Random Access Channel) comprising an indication of a first set of resources for the NR PRACH, wherein the configuration for the NR PRACH is based at least in part on a configuration for a SSB (Synchronization Signal Block) comprising an indication of a second set of resources associated with the SSB;
generate a random access preamble;
map the random access preamble to a PRACH occasion of the first set of resources; and
send an indication of the first set of resources to a memory via the memory interface.

55. The apparatus of claim 54, wherein the higher layer signaling comprises a SIB (System Information Block).

56. The apparatus of claim 54, wherein the processing circuitry is further configured to determine a mapping between the SSB and the NR PRACH based at least in part on the configuration for the NR PRACH and the configuration for the SSB.

57. The apparatus of claim 56, wherein the mapping is based on one or more of a preamble domain, a frequency domain, or a time domain, and wherein an order of the mapping is based on associated priorities for the one or more of the preamble domain, the frequency domain, or the time domain.

58. The apparatus of claim 57, wherein, for a plurality of PRACH occasions comprising the PRACH occasion, the order of the mapping is:
mapping first in the preamble domain in increasing order of preamble indexes within each PRACH occasion of the plurality of PRACH occasions,
mapping second in the frequency domain in increasing order of frequency resource indexes for one or more frequency multiplexed PRACH occasions of the plurality of PRACH occasions,
mapping third in the time domain in increasing order of time resource indexes for one or more time multiplexed PRACH occasions of the plurality of PRACH occasions, and
mapping fourth in increasing order of indexes for PRACH slots comprising one or more PRACH occasions of the plurality of PRACH occasions.

59. The apparatus of claim 54, wherein a PRACH format of the random access preamble is based at least in part on a starting symbol of the PRACH occasion of the first set of resources.

60. The apparatus of claim 54, wherein a PRACH format of the random access preamble is independent of a starting symbol of a PRACH occasion of the first set of resources.

61. The apparatus of claim 60, wherein the PRACH format is one of A2, A3, B2, B3, or B4.

62. The apparatus of claim 60, wherein the configuration for the NR PRACH configures both an A format PRACH and a B format PRACH, and wherein the processing circuitry is configured to:
generate the random access preamble based on the B format PRACH when the PRACH occasion is a last PRACH occasion of a slot; and
generate the random access preamble based on the A format PRACH when the PRACH occasion is not the last PRACH occasion of the slot.

63. The apparatus of claim 54, wherein the processing circuitry is further configured to determine a slot index for the PRACH occasion of the first set of resources based on applying modular arithmetic in connection with the indication of the first set of resources.

64. The apparatus of claim 54, wherein the PRACH occasion overlaps with reserved resources, and wherein the PRACH occasion has a higher priority than the reserved resources.

65. An apparatus configured to be employed in a gNB (next generation Node B), comprising:
a memory interface; and
processing circuitry configured to:
generate higher layer signaling indicating a first set of resources for a NR (New Radio) PRACH (Physical Random Access Channel), wherein the configuration for the NR PRACH is based at least in part on a second set of resources associated with a SSB (Synchronization Signal Block);
process a random access preamble from a PRACH occasion of the first set of resources; and
send the random access preamble to a memory via the memory interface.

66. The apparatus of claim 65, wherein the first set of resources are based on a mapping from the second set of resources according to a mapping rule.

67. The apparatus of claim 66, wherein the mapping rule is based on one or more of a preamble domain, a frequency domain, or a time domain, wherein the order of the mapping of the one or more of the preamble domain, the frequency domain, or the time domain is based on associated priorities of the one or more of the preamble domain, the frequency domain, or the time domain.

68. The apparatus of claim 67, wherein, for a plurality of PRACH occasions comprising the PRACH occasion, the order of the mapping is:
mapping first in the preamble domain in increasing order of preamble indexes within each PRACH occasion of the plurality of PRACH occasions,
mapping second in the frequency domain in increasing order of frequency resource indexes for one or more frequency multiplexed PRACH occasions of the plurality of PRACH occasions,
mapping third in the time domain in increasing order of time resource indexes for one or more time multiplexed PRACH occasions of the plurality of PRACH occasions, and
mapping fourth in increasing order of indexes for PRACH slots comprising one or more PRACH occasions of the plurality of PRACH occasions.

69. The apparatus of claim 65, processing circuitry is further configured to determine a slot index for the PRACH occasion of the first set of resources based on applying modular arithmetic in connection with the indication of the first set of resources.

70. The apparatus of claim 65, wherein a PRACH format of the random access preamble is independent of a starting symbol of a PRACH occasion of the first set of resources.
